(19) United States
(12) Patent Application Publication
(10) Pub. No.: US 2002/0131761 A1
(43) Pub. Date: Sep. 19, 2002

(54) Information recording medium, apparatus and method for recording/reproducing information to/from the medium

(76) Inventors: Kojiro Kawasaki, Katano-shi (JP); Wataru Ikeda, Osaka-shi (JP); Kazuhiko Nakamura, Hirakata-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/046,580

(22) Filed: Jan. 16, 2002

(30) Foreign Application Priority Data
Jan. 16, 2001 (JP) 2001-007899

(51) Int. Cl. H04N 5/781

(52) U.S. Cl. 386/65; 386/95; 386/125

(57) ABSTRACT

In recording AV digital stream to a recording medium, the apparatus creates a time map including an address on the medium of AV data that is related to a playback time of the AV data for each encoding data unit, when a playback time information (PTS: Presentation Time Stamp) of the AV digital stream can be identified. The apparatus creates a time map including an address on the medium of AV data that is related to a packet arrival time (ATS: Arrival Time Stamp) of the AV data, when the playback time information (PTS) of the AV digital stream can not be identified.

### BACKGROUND OF THE INVENTION

1. Field of the Invention

The present invention relates to readable/writable information recording medium, more specifically, to an information recording medium for storing multimedia data in different kinds of data such as movie image data and audio data. Further the present invention relates to a data recording apparatus and reproducing apparatus for such the recording medium.

2. Related Art

Development of phase change type disc DVD-RAM has increased recording capacity of a rewritable optical disc from about 650 MB to a few GB. The DVD-RAM is now expected to become a medium not only for computers but also a recording/playing medium for audio/video (hereinafter abbreviated as AV) technologies in combination with standardization of a digital AV data coding technique called MPEG (MPEG2). Specifically, the DVD-RAM is expected to replace magnetic tape which has been a major AV recording medium. (DVD-RAM)

Advancement in high-density recording technology for rewritable optical discs in recent years has made it possible to store not only computer data and audio data but also image data as well.

Conventionally, land and groove are formed on a signal recording surface of the optical disc.

Signals used to be recorded only on the land portion or in the groove portion. Later, land-group recording method was developed for recording signals both in the land portion and in the groove portion, practically doubling the recording density. For example, a technique disclosed in Japanese Patent Laid-Open Publication No. 8-7282 is well known.

Another of such techniques is CLV (Constant Linear Velocity recording) method for improving recording density. From this technique, zone CLV method was developed and is now commercially practiced for simplified control in application. Japanese Patent Laid-Open Publication No. 7-93873 is a known example of this technique.

With such development in the optical disc for greater recording capacity, a technological challenge is how to record AV data including image data, thereby achieving new performances and functions that have never been realized by prior art AV apparatuses.

The development of the large-capacity rewritable optical disc is expected to replace the conventional tape medium for recording/playing AV data. The change from tape to disc will bring substantial changes in the function and performance of the AV equipment.

The biggest change to be brought by the disc is tremendous improvement in random access capability. If tape is to be accessed randomly, rewinding time of the tape, which is usually a few minutes per reel, must be taken into account. Such an access time is extremely slower than a seek time (which is shorter than a few tens of millisecond.) for the optical disc. Thus, in a practical sense, the tape cannot be a random access medium.

Such a superb random access capability of the optical disc can realize distributed recording of AV data in the optical disc, which was not possible with the conventional tape medium.

Referring now to the attached drawings, FIG. 1 is a block diagram of a DVD recorder drive unit. The drive unit comprises an optical pickup 11 for reading data stored in a DVD-RAM disc 10, an ECC (Error Correcting Code) processor 12, a one-track buffer 13, a switch 14 for selecting between input and output to and from the track buffer 13, an encoder 15, and a decoder 16.

As shown in the figure, the DVD-RAM disc 10 uses one sector (1 sector=2 KB) as a smallest unit of data recording, and one ECC block (1 ECC block=16 sectors) is used as a unit for error correcting operation performed by the ECC processor 12.

The track buffer 13 is a buffer for storing AV data at a variable bit rate to record AV data effectively in the DVD-RAM disc 10. Specifically, reading/writing for the DVD-RAM 10 is performed at a fixed rate (Va), whereas the bit rate (Vb) of AV data is varied according to complexity of contents (e.g. an image for video data). The buffer 13 absorbs difference between these two bit rates. When the AV data have a fixed bit rate such as in a video CD, then the track buffer 13 is not required.

If this track buffer 13 is used more effectively, distributed recording of AV data on the disc 10 becomes possible. This will be described more specifically here below, referring to FIGS. 2A and 2B.

FIG. 2A is a diagram showing address space on the disc. According to FIG. 2A, AV data is stored in a distributed manner, i.e. in a continuous area [a1, a2] and in another continuous area [a3, a4]. In such a case, the AV data can be replayed continuously supplying data stored in the buffer 13 to the decoder portion 16 while seek is being made from point a2 to point a3. This situation is shown in FIG. 2B.

The AV data starting from the location al are read, and then entered to the track buffer 13 from time t1, upon which time the track buffer 13 begins to output the data. Thus, the buffer 13 accumulates data at a rate equal to the difference (Va−Vb) between the input rate (Va) to the buffer 13 and the output rate (Vb) from the buffer 13. This situation continues until the retrieval reaches a2 represented by a time point t2, by which time the amount of data in the buffer 13 has accumulated to amount B(t2). From time t2 to time t3, until the data pickup operation is resumed from the area starting at a3, the amount of data B(t2) stored in the track buffer 13 is being consumed in order to keep the decoder 16 supplied with data.

In other words, when the amount of data ([a1, a2]) read before the seeking is greater than a certain volume, then the AV data can be continuously supplied without being interrupted by the seek.

The above description is for reading of data from the DVD-RAM, i.e. for a play back operation. The same goes with writing data to the DVD-RAM, i.e. for a recording operation.

As described above, with the DVD-RAM, continuous replaying/recording is possible even if AV data is stored in the distributed manner, as long as the amount of data on each continuous record is greater than a certain volume.

In order to enhance advantages of the large-capacity recording medium, i.e. DVD-RAM, a UDF (Universal Disc Format) file system is used in the DVD-RAM as shown in FIG. 3 to allow access to the disc by using a PC. UDF information is recorded in “Volume” area of the diagram. Details of the UDF file system is disclosed in the “Universal Disc Format Standard.”

(Prior-Art AV Equipment)

Next, description will be made for prior art AV equipment commonly used by many users.

FIG. 4 is a diagram showing relationships among conventional AV equipment, media and formats. For example, if a user wants to watch a video program, a videocassette must be loaded into a VTR, and the program must be viewed using a TV set. If the user wants to listen to music, then a CD must be loaded into a CD player or CD radio-cassette player, and the program must be listened through a speaker system or through headphones. Specifically, according to the conventional AV system, each format (video or audio) is paired with a corresponding medium, respectively.

For this reason, each time when listening or watching a program, the user must select an appropriate medium and change one to another AV equipment appropriate to the medium. This is inconvenient from the user's viewpoint.

(Digitization)

Meanwhile, along with recent popularization of digital technology, a DVD videodisc was introduced as package software, whereas satellite digital broadcast was introduced in the broadcasting industry. These developments are backed by digital technology innovation, especially by MPEG as an internationally accepted standard.

FIG. 5 is a diagram showing MPEG streams used in the DVD videodisc and the satellite digital broadcast mentioned above. The MPEG standard has a hierarchy structure as shown in FIG. 5. An important point to note here is that the MPEG stream eventually used by an application in the package medium such as the DVD videodisc is different from the MPEG stream in the communication medium such as the satellite digital broadcasting. The former is called “MPEG program stream”., in which data transfer is made by the unit of pack, reflecting the size of a sector (2048 bytes in DVD video disc) as the unit of recording in the package software. On the other hand, the latter is called “MPEG transport stream”, in which the unit of data transfer is a TS packet having a size of 188 bytes, reflecting the application to ATM (Asynchronous Transfer Mode) systems.

The MPEG is expected to eliminate borders between different AV media, as a universal coding technology of image signals and digital data. However, because of such small differences as described above, there is not yet any AV equipment or media capable of handling both the package media and communication media.

(Changes Brought by DVD-RAM)

Introduction of the large capacity DVD-RAM is a step forward to elimination of the inconvenience that users feel in conventional AV equipment. As described earlier, the DVD-RAM incorporated with the UFD file system is accessible from the PC. By using different pieces of application software on the PC, it is now possible to play varieties of contents such as video, still picture and audio programs on a single piece of equipment, i.e. the PC.

As shown in FIG. 6, the user can move a cursor with a mouse onto a file displayed on a screen, and then double-click (or single-click) to replay contents of the file such as a movie displayed in left-top area of the screen.

Such a convenience becomes possible by combination of flexibility offered by the PC and large storage capacity offered by the DVD-RAM.

Backed by increasing popularity of the PC in recent years a number of different AV data can now be handled fairly simply on the PC as shown in FIG. 6. However, even though number of PC users is expected to increase, the popularity and easiness of operation of the PC are not so high and simple as those of the home TV or home video systems.

It is therefore an object of the present invention to solve the following problems identified as hurdles to optimum performance of the optical discs such as the DVD-RAM.

A world to be realized by the DVD recorder would be a world in which the user can freely handle different formats and contents without caring about the differences, by using a single medium on a single piece of AV equipment as shown in FIG. 7.

FIG. 8 shows an example of a menu used in the DVD recorder. According to this menu, the user can select from 1) “The Foreign Movie Theater” recorded from satellite digital broadcasting, 2) “The Morning Drama Series”, 3) “The World Cup Finals” each recorded from an analog broadcasting, and 4) a Beethoven dubbed from a CD, on a TV screen without caring about the original medium or the recording format.

The biggest problem in developing such a DVD recorder as above is how to manage uniformly the AV data and streams of many different formats.

No special managing method will be necessary if only a limited number of existing formats are to be handled. However, a managing method capable of handling not only a number of existing formats but also new formats to be introduced in the future has to be developed in order to realize the above-mentioned world of DVD recorder.

Even so, certain difference between a future user interface and those incorporated in the capability of uniformly handling the different AV streams may create a certain level of inconvenience similar to the inconvenience described for the prior-art. Specifically, the user may have to perform different operation depending upon the contents or format.

It becomes a big problem to handle how received data digitized by, for example, digital broadcasting among various AV streams. Particularly, in the case of MPEG stream, there is no concept of random access in the middle of the stream, since MPEG is standardized for application to the broadcast or communication. Therefore, it is impossible to use sufficiently random accessibility which is the best characteristic of disc media when data is stored to the optical disc.

### SAMMARY OF THE INVENTION

The present invention is made to solve the above problem, and therefore has an object to provide an information recording medium capable of recording MPEG stream which lacks random accessibility in the middle of the stream, together with different kinds of AV streams. The present invention is also directed to provide a recording apparatus and a reproducing apparatus for the information recording medium.

An information recording medium according to the invention is a recording medium storing digital data and management information managing the digital data. The management information includes first time map information and second time map information. The first time map information is provided for a first object that is a digital stream. In the digital stream, digital data is packet-multiplexed, and for each predetermined unit, an address on the medium of the digital data is related to a playback time of the digital data and stored to the medium. The second time map information is provided for a second object that is a digital stream. In the digital stream, digital data is packet-multiplexed for each predetermined unit, its contents can not be identified, and for each predetermined unit, an address on the medium of the digital data is related to an arrival time of the packet and stored to the medium.

According to the recording medium of the invention, the transport stream which is received via digital broadcasting can be recorded to the recording medium along with the other AV streams. Random access can be performed to the recorded digital broadcasting object. Further it becomes possible to perform special plays such as a fast forwarding play or a reverse direction play. It can also provide random access to the disc even when the contents of transport stream can not be identified.

A recording apparatus according to the invention is an apparatus for recording a digital stream in which digital data is packet-multiplexed to a recording medium. The recording medium is capable of storing first time map information and second time map information. In the first time map information, for each predetermined unit, an address on the medium of the digital data is related to a playback time of the digital data and stored. In the second time map information, for each predetermined unit, an address on the medium of the digital data is related to an arrival time of the packet. The apparatus includes I/F section that receives the digital stream from external, map creation section that creates the time map information according to the received digital stream, and recording section that records the digital stream and the time map information to the recording medium. In recording the digital stream to the recording medium, the map creation section analyzes the digital stream, and based on the analysis result creates the first time map information when the playback time information can be identified, or creates the second time map information when the playback time information can not be identified.

A recording method according to the invention is a method of recording a digital stream in which digital data is packet-multiplexed to a recording medium. The recording medium is capable of storing fist time map information and second time map information. In the first time map information, for each predetermined unit, an address on the medium of the digital data is related to a playback time of the digital data and stored. In the second time map information, for each predetermined unit, an address on the medium of the digital data is related to an arrival time of the packet and stored. The method includes analyzing the digital stream for recording the digital stream to the recording medium, creating the first time map information when the playback time information can be identified, or creating the second time map information when the playback time information can not be identified, based on the analysis result, and recording the digital stream and the time map information to the recording medium.

According to the recording apparatus or the recording method of the invention, the transport stream which is received via digital broadcasting can be recorded to the recording medium so that random access can be performed to the recorded stream at reproducing operation.

A reproducing apparatus according to the invention is an apparatus for reproducing information from a recording medium storing a digital stream in which digital data is packet-multiplexed. The recording medium is capable of storing first time map information in which, for each predetermined unit, an address on the medium of the digital data is related to a playback time of the digital data and stored, and second time map information in which, for each predetermined unit, an address on the medium of the digital data is related to an arrival time of the packet and stored. The apparatus includes reproducing section that reads and reproduces the digital stream from the recording medium, I/F section that receives information to designate the digital stream to be reproduced and information to designate start time of the playback, and control section to control the reproducing section. The control section controls the reproducing section so as to determine whether the time map information of the designated digital stream is the first time map information or the second time map information, specify a read address with reference to the time map information by using a time axis according to the type of the time map information, and then start the playback from the specified address.

A reproducing method according to the invention is a method of reproducing information from a recording medium storing a digital stream in which digital data is packet-multiplexed. The recording medium is capable of storing first time map information in which, for each predetermined unit, an address on the medium of the digital data is related to a playback time of the digital data and stored, and second time map information in which, for each predetermined unit, an address on the medium of the digital data is related to an arrival time of the packet and stored. The method includes reading and reproducing the digital stream from the recording medium, receiving information to designate the digital stream to be reproduced and information to designate start time of the playback, and controlling the playback. The controlling includes determining whether the time map information of the designated digital stream is the first time map information or the second time map information, specifying a read address with reference to the time map information by using a time axis according to the type of the time map information, and then starting the playback from the specified address.

According to the reproducing apparatus or the reproducing method of the invention, it is possible to perform random access to the transport stream which is received via digital broadcasting and then stored to the recording medium along with other kinds of AV streams.

A program according to the invention is a program capable of enabling a computer to operate as the recording apparatus described above. The program may be stored to a computer readable recording medium to be supplied.

### BRIEF DESCRIPTION OF THE DRAWINGS

FIG. 1 is a block diagram of a drive unit of a DVD recorder.

FIG. 2A is a diagram showing address space on a disc.

FIG. 2B is a diagram showing data accumulation in a track buffer.

FIG. 3 is a diagram showing a file structure through a file system.

FIG. 4 is a diagram showing relationships among different kinds of prior art AV equipment and corresponding media.

FIG. 5 is a diagram showing an MPEG program stream and an MPEG transport stream.

FIG. 6 is an illustration of a PC screen when an AV data file is being accessed on the PC.

FIG. 7 is a diagram showing relationships to be created by a DVD recorder among different kinds of AV equipment.

FIG. 8 is an example of a selection menu given by the DVD recorder.

FIG. 9A is a diagram showing relationships between an AV file and a directory on the computer readable DVD-RAM disc.

FIG. 9B is a diagram showing address space on the disc.

FIG. 10 is a diagram showing relationships among an object, object information and PGC information.

FIG. 11 is a diagram showing management information derived from the object information for each stream.

FIGS. 12A, 12B and 12C are diagrams explaining time maps provided for digital broadcasting object (D_VOB) and stream object (SOB) respectively.

FIGS. 13A, 13B and 13C are diagrams describing PAT and PMT packets included in the transport stream.

FIG. 14 is a diagram showing relationships among a movie object (M_VOB), movie object information (M_VOBI), and PGC information.

FIGS. 15A, 15B, 15C, 15D, 15E and 15F are diagrams describing address conversion using a time map according to the present invention.

FIGS. 16A, 16B, 16C and 16D are diagrams each of which shows each stage of the MPEG transport stream.

FIG. 17 is a diagram showing relationships between an audio object (AOB), audio object information (AOBI) and PGC information.

FIG. 18 is a diagram showing relationships among a still picture object (S_VOBS), still picture object information (S_VOBSI), and PGC information.

FIG. 19 is a diagram showing relationships among a stream object (SOB), stream object information (SOBI), and PGC information.

FIG. 20 is a block diagram of a player model according to the present invention.

FIG. 21 is a block diagram of the DVD recorder according to the present invention.

FIG. 22 is a flowchart of time map creation process.

FIG. 23 is a block diagram of a DVD player or a data reproducing apparatus according to the present invention.

FIG. 24 is a diagram showing the basic structure of a time map for a digital broadcasting object (D_VOB).

FIG. 25 is a diagram showing a relationship between cell information and the time map during the reproduction operation of the digital broadcasting object.

FIG. 26 is a diagram showing a method of using the time map during the special reproduction of the digital broadcasting object.

FIG. 27 is a diagram showing a relationship between a stream and the time map during the deletion operation of the digital broadcasting object.

FIG. 28 is a diagram showing application of the time map to the multistream.

FIG. 29 is a flowchart showing a process of creating the time map.

FIG. 30 is a flowchart showing an entry adding process in each of the time maps.

FIG. 31 is a flowchart showing a data reproducing process with reference to the time map.

FIG. 32 is a flowchart showing a specific data reproducing process.

FIGS. 33A, 33B and 33C are diagrams showing the data structure of D_VOB in the third embodiment.

FIG. 34 is a diagram showing the data structure of D_VOB time map information in the third embodiment.

FIG. 35 is a diagram showing relationships among the time map table of D_VOB, VOBU table and D_VOB.

FIG. 36 is a diagram showing relationships among the time map table of D_VOB, VOBU table and D_VOB.

FIGS. 37A and 37B are diagrams explaining a method of designating a size of a reference picture.

FIG. 38 is a diagram showing the data structure of D_VOB time map information.

FIG. 39 is a diagram showing relationships among the time map table of D_VOB, VOBU table and D_VOB.

FIG. 40 is a flowchart of creation process of D_VOB time map information.

FIG. 41 is a flowchart showing an entry adding process in each of D_VOB time maps.

FIG. 42 is a flowchart showing a data playback process with reference to D_VOB time map information.

FIGS. 43A, 43B and 43C are diagrams showing the data structure of D_VOB in the fourth embodiment.

FIGS. 44A and 44B are diagrams showing the data structure of D_VOB time map information in the fourth embodiment.

FIGS. 45A, 45B and 45C are diagrams showing the data structure of SOB.

FIG. 46 is a diagram showing the data structure of SOB time map information in the third embodiment.

FIG. 47 is a diagram showing the data structure of SOB time map information in the third embodiment.

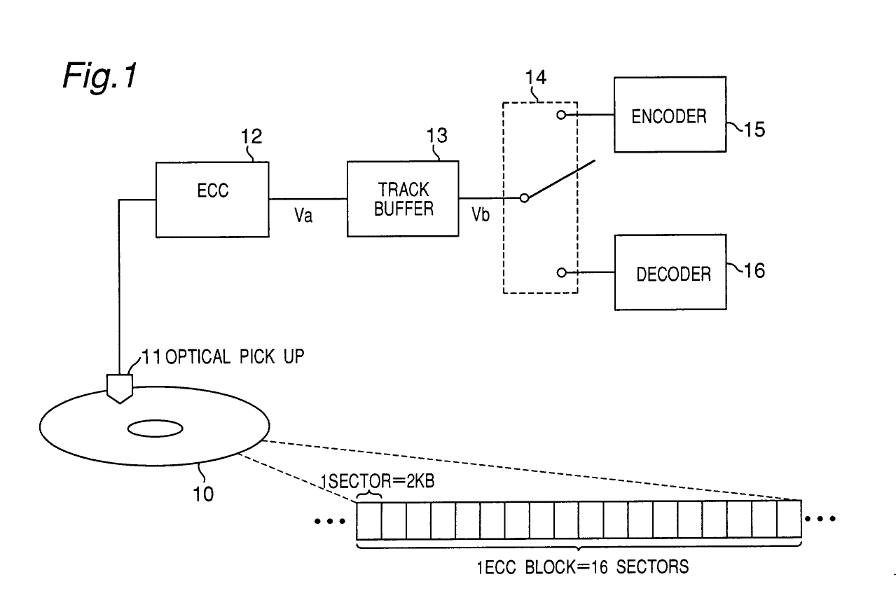

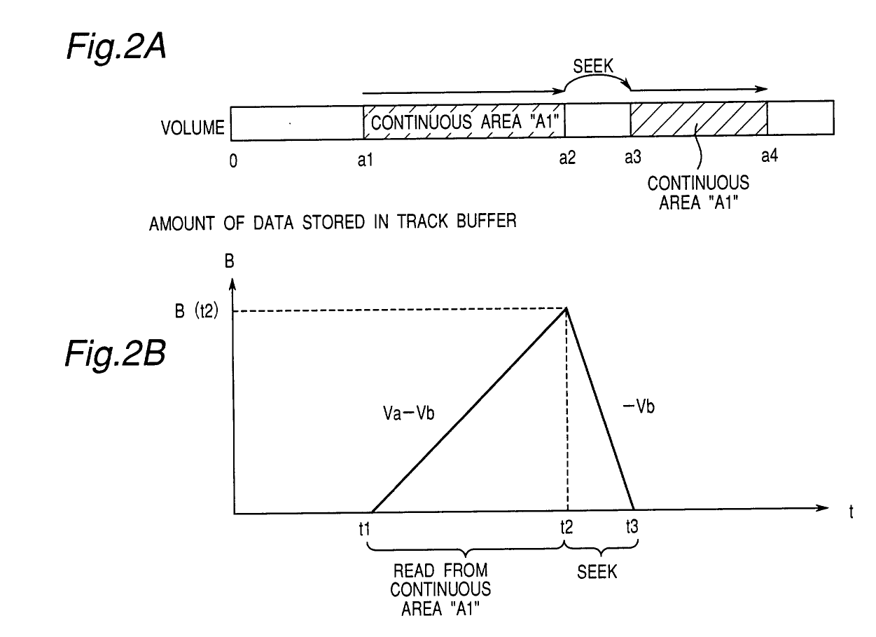

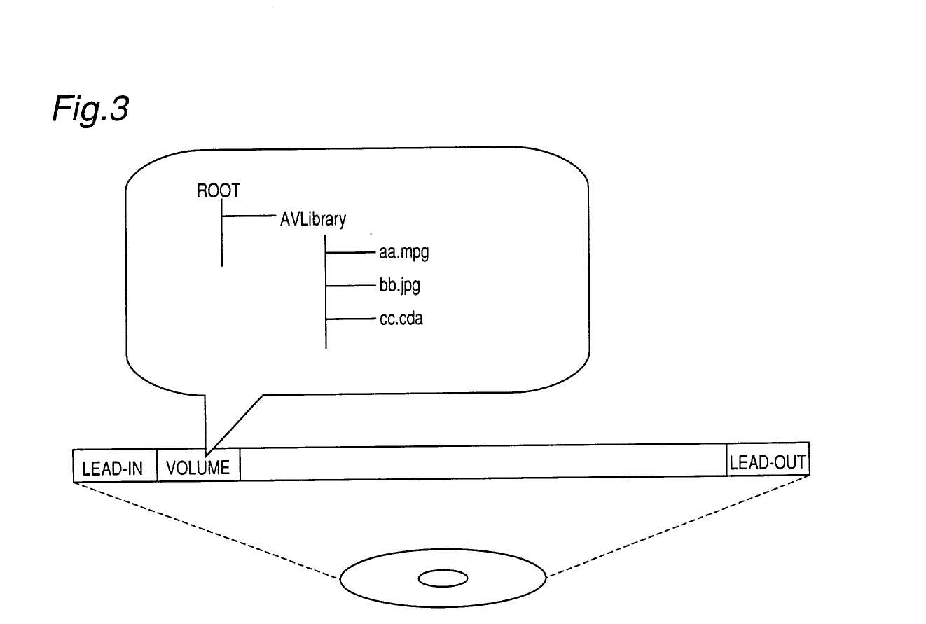

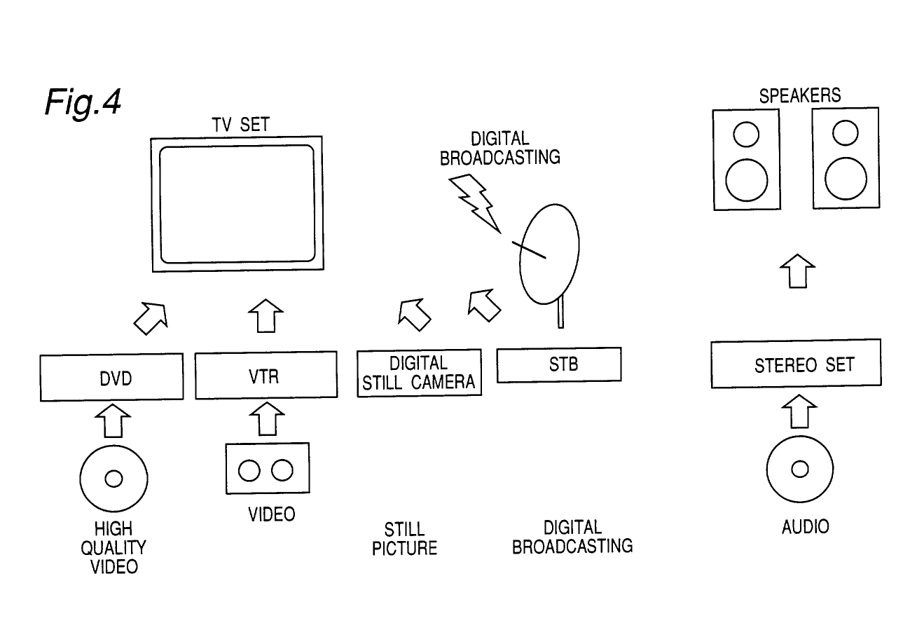

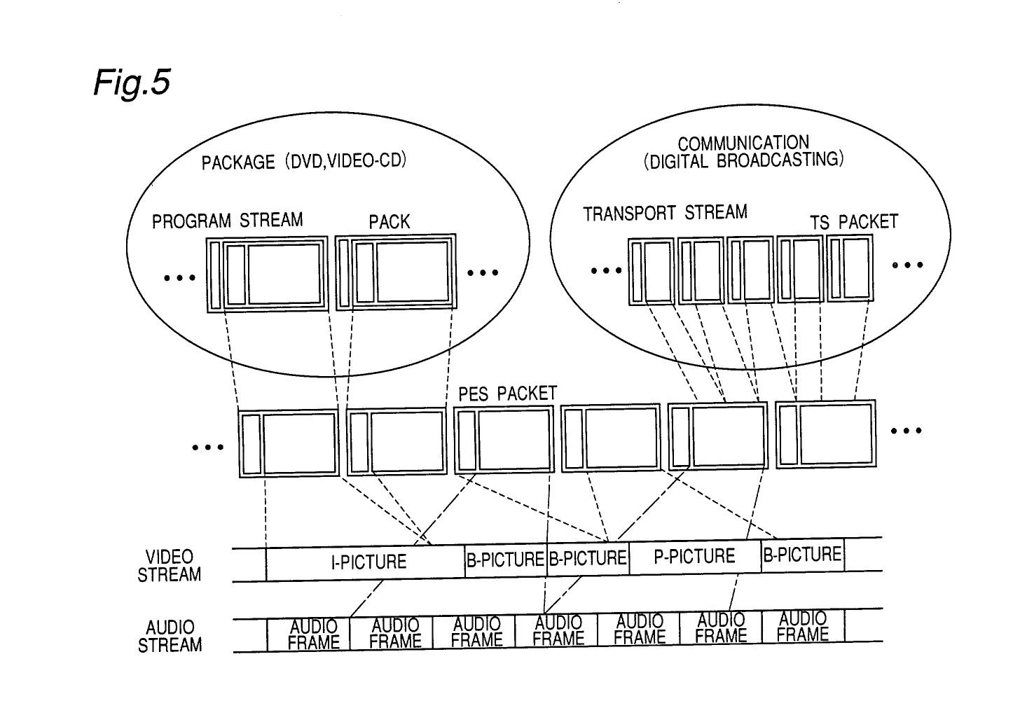

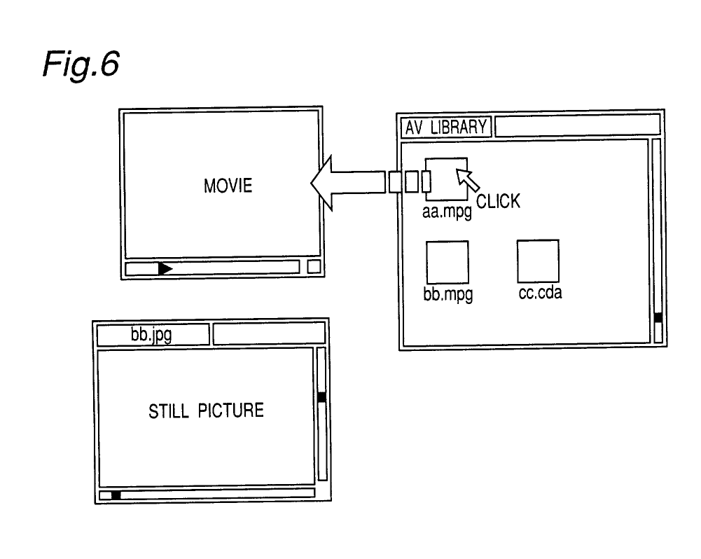

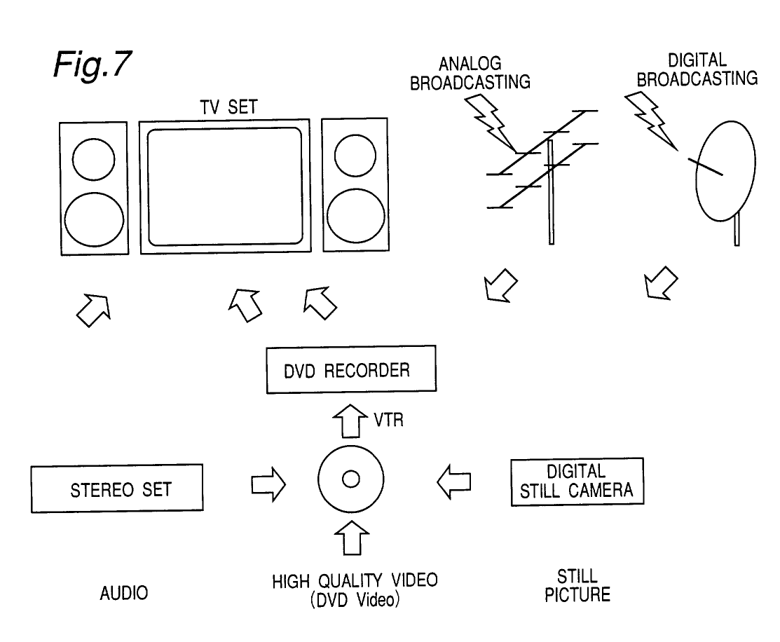

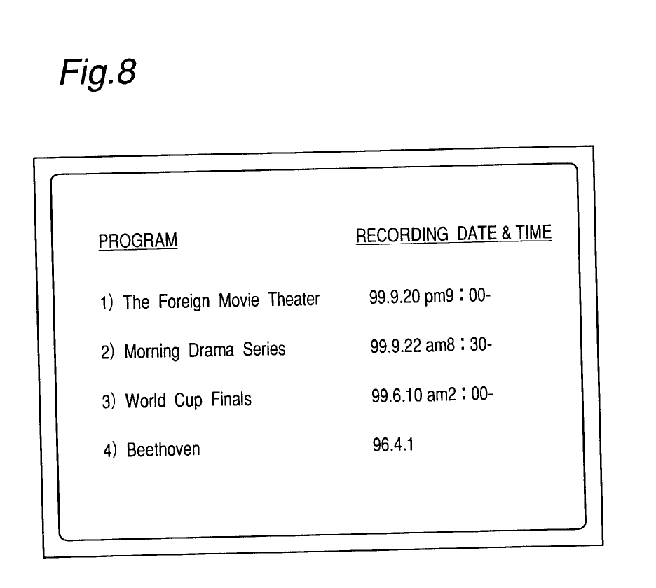

### DETAILED DESCRIPTION OF THE PREFERRED EMBODIMENTS

With reference to the accompanying drawings, detailed description will be made for a DVD-RAM, a DVD recorder, and a DVD player as preferred embodiments of the recording medium, the recording apparatus and the reproducing apparatus according to the present invention.

<First Embodiment>

(Logic Structure of Data on DVD-RAM)

The DVD-RAM according to the present invention makes possible to record and manage integrally AV data and AV streams of many different kinds of formats on a single disc. This allows it to record on a single disc AV streams of different formats including an analog broadcasting program, a digital broadcasting program transmitted in the MPEG transport stream (MPEG-TS), a video stream taken by a digital video camera, a still picture taken by a digital still camera, and video data coded in the MPEG program stream (MPEG-PS), and so on. Further, the data recorded in the DVD-RAM can be played in a given sequence. For this purpose, the DVD-RAM according to the present invention is provided with management information for managing the AV streams without depending on the types of format of the AV data or AV streams.

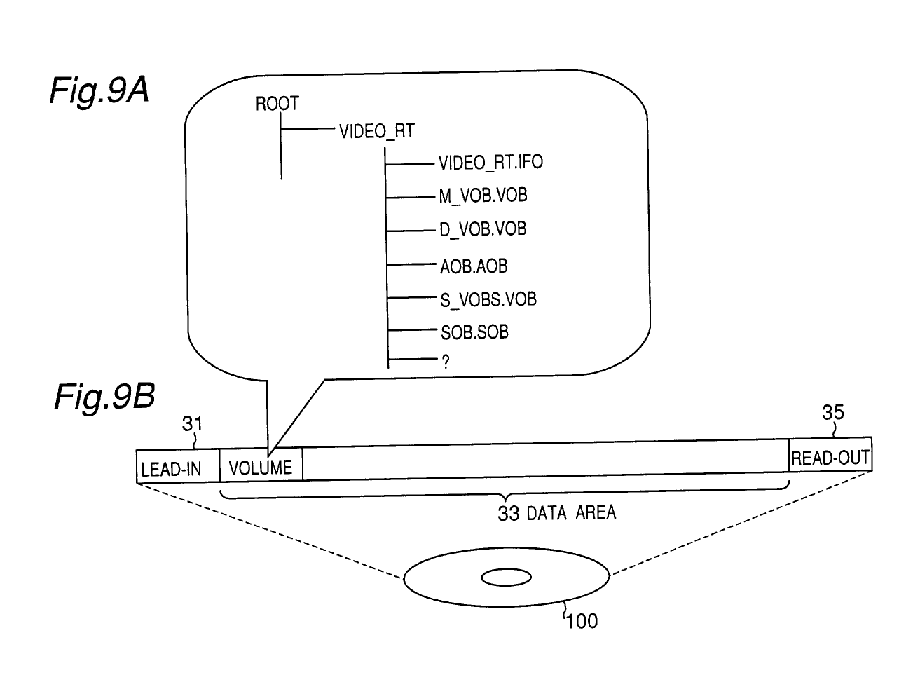

First, structure of the data recorded in the DVD-RAM according to the present invention is described with reference to FIGS. 9A and 9B. A diagram in FIG. 9A is a data structure of a DVD-RAM disc 100, which can be seen by a file system. FIG. 9B shows a structure of a physical sector in the disc 100.

As shown in the figure, a first portion of the physical sector is a lead-in area 31 which stores therein standard signals necessary for stabilizing servo mechanism, identification signals for differentiating from other media, and so on. The lead-in area 31 is followed by a data area 33 which stores logically available data. A last portion is a lead-out area 35 storing signals similar to those in the lead-in area 31.

A front portion of the data area 33 stores with volume information which is management information for the file system. Since the file system is a known technique, no details will be described herein.

The file system allows the data in the disc 100 to be handled as directories and files as shown in FIG. 9A. As understood from FIG. 9A, all the data handled by the DVD recorder is managed under VIDEO_RT directory immediately below the ROOT directory.

The DVD recorder according to the present embodiment handles two kinds of files, i.e. AV files containing audio-video data (AV data), and management information files containing information for managing the AV files. According to the example shown in FIG. 9A, the management information file is identified as “VIDEO_RT. IFO”, whereas the AV files include a file “M_VOB.VOB” which contains movie data, “D_VOB.VOB” which contains image data from digital broadcasting, “AOB. AOB” which contains audio data, and so on. Each of these files will be detailed here below.

It should be noted here that according to the present embodiment, each AV stream is defined as an object (“Object”). Specifically, the objects may include a variety of AV streams such as MPEG program stream (MPEG-PS), MPEG transport stream (MPEG-TS), audio stream, still picture data, and so on. Each of these data is abstracted as the object so that the management information of these data can be defined as object information (Object I) of a universal format. The object includes, for example, a movie video object (M_VOB) that is an object for video data, an audio object (A_VOB) that is an object for audio data, a still picture object (S_VOB) that is an object for a group of still picture data, a digital video object (D_VOB) that is an object for digital broadcasting data, and a stream object (SOB) that is an object for digital broadcasting data and particularly for general data of which content can not be recognized.

(Management Information)

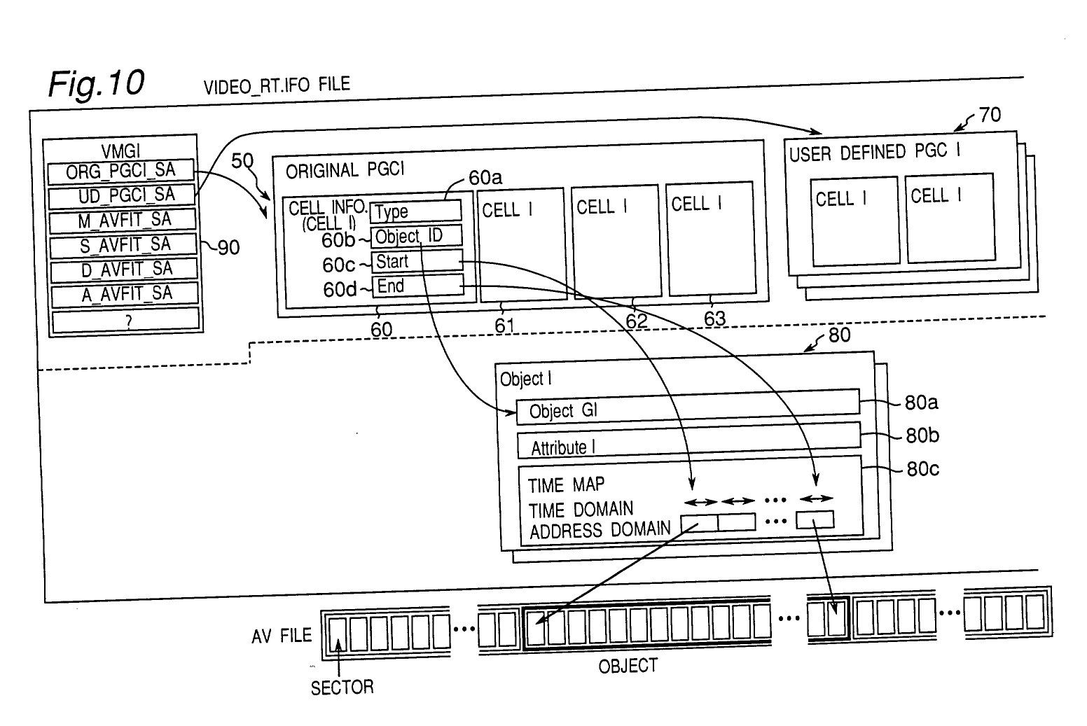

First, the management information will be described referring to FIG. 10. The management information has object information 80 for management of recording locations of the object and attribute thereof, and program chain information (PGC information) 50 and 70 which define playback sequence, playback time and so on for data to be played back from the DVD-RAM.

The above-described abstraction is possible for the AV streams because the AV streams have time attribute and other elements in common, although each of the different formats has certain differences from the others. AV streams having a common format are stored in the same AV file in the order of recording.

The object information (Object I) 80 includes general information about the object (Object GI) 80a, attribute information of the object (Attribute I) 80b, and a time map 80c for converting the object playback time into addresses on the disc.

The time map 80c is necessary because the AV stream generally has two standards, i.e. a time domain and a data (binary digit string) domain, which do not have perfect correlation with each other. For example, in a video stream coded by MPEG-2 video which is now an international standard of the video stream, use of variable bit rate (a method in which the bit rate is changed depending on the level of complexity of an image) is becoming a mainstream. According to this method, there is no proportional relationship between the amount of data from the beginning and the accumulated length of playback time, and therefore random accessing cannot be performed based on the time axis. In order to solve this problem, the object information 80 has the time map 80c for conversion between the time axis and the data (binary digit string) axis. As will be described later, one object comprises a plurality of object units (VOBU), and therefore the time map 80c has data that correlates or associates the time region with the address region for each of the object units.

The PGC information 50, 70 are the information for controlling the playback of the object, i.e. image data and audio data. The PGC information 50, 70 represent a unit of data to be played back when the DVD player plays continuously data back. Specifically, each of the PGC information 50, 70 indicates an object to be replayed, and a playback sequence of cells 60, 61, 62 and 63. Each of cells 60, 61, 62 and 63 indicates any playback section of this particular object. The cells 60, 61 . . . will be described later in more detail. The PGC information comprises two kinds of information comprising an original PGC information 50 and a user defined PGC information 70. The original PGC information 50 is automatically generated by the DVD recorder upon recording the object so that all of the recorded objects are included. On the other hand, with the user-defined PGC information 70, the user can freely define the playback sequence. The PGC information 50 and 70 have the same structure and function differing only in that the user-defined PGC information 70 is defined by the user. Thus, description in further detail will be made only for the original PGC information 50.

As shown in FIG. 10, the original PGC information 50 includes at lease one of the cell information. The cell information 60 . . . specifies an object to be replayed, and a replay section of the object. Generally, the PGC information 50 records a plurality of cells in a certain sequence. This recording sequence of the cell information in the PGC information 50 indicates the sequence in which the objects specified in respective cells are replayed.

Each cell, the cell 60 for example, includes type information (“Type”) 60a which indicates the kind of object specified, an object identification (Object ID) 60b which identifies the object, starting position information (“Start”) 60c on the time axis of the object, and ending position information (“End”) 60e on the time axis in the object.

When the data is replayed, the cell information 60 in the PGC information 50 is read out successively, so that the object specified by the cell is replayed by successively playing portions of the object represented by the playback sections specified by respective cells.

(Subclasses of the Object Information)

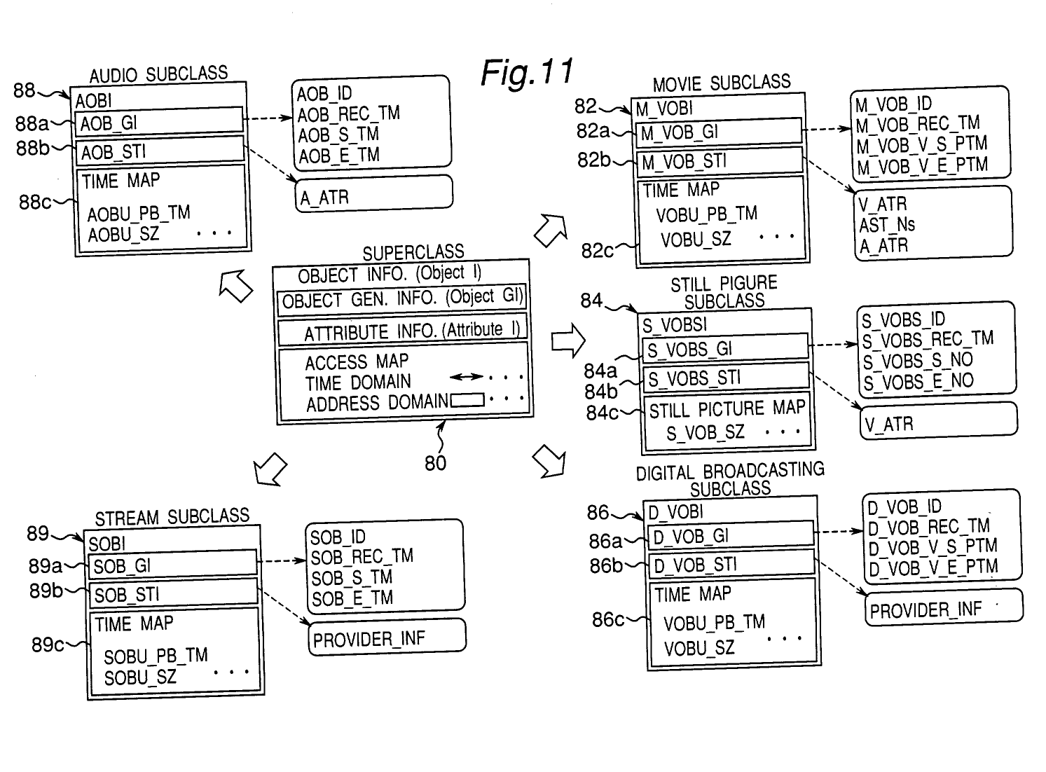

In order for the abstracted object information to be applied to an actual AV stream, a concretization must be provided. This principle may be understood easily as the class concept employed in an object-oriented model. More specifically, understanding will become easier if the object information is considered as a super-class, and more concrete structures created for each of the AV streams are considered as subclasses. FIG. 11 shows these concretized subclasses.

According to the present embodiment, as shown in FIG. 11, the object information has subclasses defined as a movie video subclass, an audio subclass, a digital broadcasting subclass, and a data broadcasting subclass. Specifically, following subclasses are defined as concrete information: movie video object information (M_VOBI) that is an object information for video data (MPEG-PS), audio object information (A_VOBI) that is an object for audio data, a still picture object information (S_VOBSI) that is an object information for a group of still picture data, a digital video object information (D_VOBI) that is an object information for digital broadcasting data, and a stream object information (SOBI) that is an object information for digital broadcasting data and particularly general data of which content can not be recognized.

The movie object information 82 includes MPEG program stream general information (M_VOB_GI) 82a, movie object stream information (M_VOB_STI) 82b, and a time map 82c.

The general information (M_VOB_GI) 82a includes movie object Identification information (M_VOB_ID), movie object recording time (M_VOB_REC_TM), movie object starting time information (M_VOB_V_S_PTM), and movie object ending time information (M_VOB_V_E PTM).

The movie object stream information (M_VOB_STI) 82b includes video stream information (V_ATR) having coding attributes of the video stream, the number of audio streams (AST_Ns), and audio stream information (A_ATR) having coding attributes of the audio stream.

The time map 82c includes a headmost address of the movie object in the AV file, playback time (VOBU_PB_TM) and data size (VOBU_SZ) of each of the movie object units (VOBU). The movie object unit (VOBU) is the smallest unit to be accessed in the movie object (M_VOB), and will be detailed later.

The digital broadcast object information (D_VOBI) 86 includes MPEG transport stream general information (D_VOB_GI) 86a, stream information (D_VOB_STI) 86b, and a time map 86c.

The general information of the digital broadcasting object (D_VOB_GI) 86a includes digital broadcasting object identification information (D_VOB_ID), digital broadcasting object recording time (D_VOB_REC_TM), digital broadcasting object starting time information (D_VOB_V_S_PTM), and digital broadcasting object ending time information (D_VOB_V_E PTM).

The digital video object stream information (D_VOB_STI) includes information (PROVIDER_INF) which contains additional information provided in the digital broadcasting. The time map 86c includes a headmost address of the digital broadcasting object (D_VOB) in the AV file, playback time (VOBU_PB_TM) and data size (VOBU_SZ) for each object unit (VOBU).

The audio object information (AOBI) 88 includes audio stream general information (AOB_GI) 88a, stream information (AOB_STI) 88b, and a time map 88c. The audio stream general information (AOB_GI) 88a includes audio object identification information (AOB_ID), audio object recording time (AOB_REC_TM), audio object starting time information (AOB_S_TM), and audio object ending time information (AOB_E_TM). The AOB stream information (AOB_STI) 88b includes audio stream information (A_ATR) having coding attributes of the audio stream. The time map 88c includes a headmost address of the audio object in the AV file, playback time (AOBU_PB_TM) and data size (AOBU_SZ) for each audio object unit (AOBU). The audio object unit (AOBU) is the smallest access unit in the audio object (AOB), and will be detailed later.

Still picture object information (S_VOBSI) 84 includes still picture general information (S_VOBS_GI) 84a, still picture stream information (S_VOBS_STI) 84b, and an S map 84c. The still picture general information (S_VOBS_GI) 84a includes still picture object identification information (S_VOBS_ID), still picture object recording time (S_VOBS_REC_TM), still picture object starting picture number (SVOBS_S_NO), and still picture object ending picture number (SVOBS_E_NO). The still picture stream information (S_VOBS_STI) 84b includes still picture attribute information (V_ATR) having information about a compression format of the still picture object. The S map 84c includes a headmost address of still picture object (S_VOBS) in the AV file, and data size (S_VOB_SZ) for each still picture.

The stream object information (SOBI) 89 includes general information (SOB_GI) 89a for input data, stream information (SOB_STI) 89b for input data, and a time map 89c. The general information (SOB_GI) 89a includes identification information (SOB_ID) of stream object, recording time (SOB_REC_TM) of stream object, start time information (SOB_S_ATS) of stream object, and end time information (SOB_E_ATS) of stream object. The stream information (SOB_STI) of stream object includes information (PROVIDER_INF) storing additional information to be transmitted. The time map 89c includes a headmost address of SOB in the file, playback time (SOBU_PB_TM) of each stream object unit (SOBU) and data size (SOBU_SZ) of each stream object unit. The stream object unit (SOBU) indicates a unit which is obtained by dividing a stream object (SOB) by a predetermined time interval, the detail of which is described later.

As described above, a stream information table corresponding to each type of AV stream can be defined as shown in FIG. 11 by putting the abstracted object information into a more concrete data.

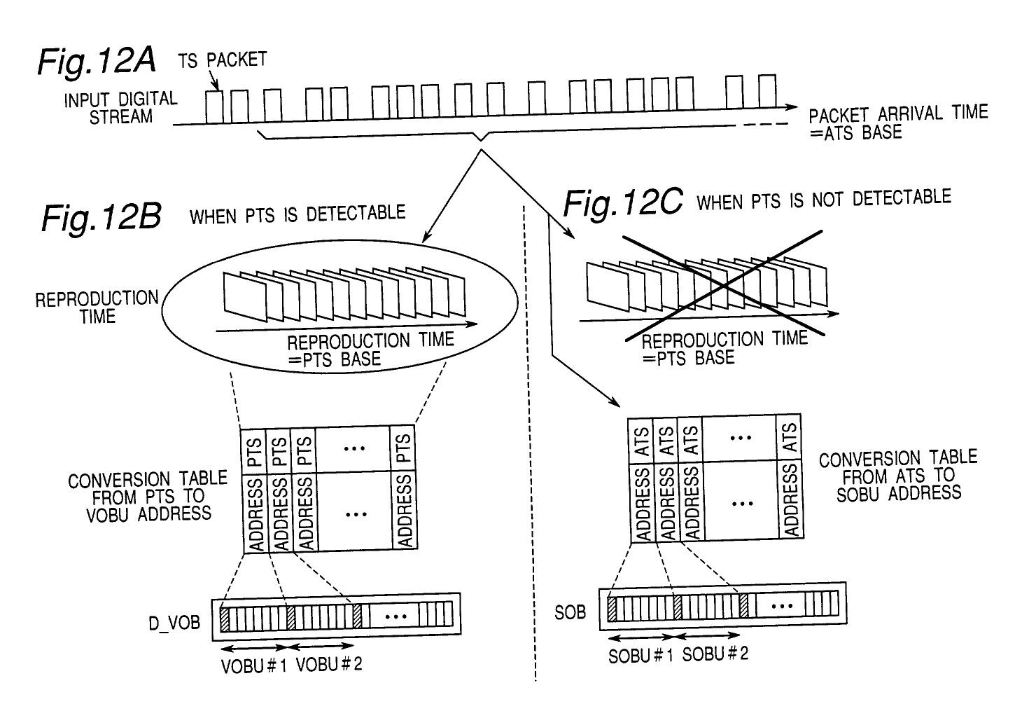

The digital broadcasting object information (D_VOBI) 86 is common with the stream object information (SOBI) 89 in that those are management information associated with objects that record digital broad casting. However, those object information has different time axes as a time standard of the time map, respectively. That is, as shown in FIG. 12B, the time map relating to the digital broadcasting object (D_VOB) uses, as a time scale, a presentation time stamp (PTS) that is information indicating a playback time (That is, the presentation time stamp (PTS) is related with the address.). On the contrary, as shown in FIG. 12C, the time map relating to the stream object (SOB) uses, as a time scale, an arrival time stamp (ATS) that is information indicating an arrival time of the packet (That is, the packet arrival time stamp (ATS) is related with the address.). The reason is as follows.

The digital broadcasting object (D_VOB) managed by the digital broadcasting object information (D_VOBI) 86 is an object of which contents of stream can be analyzed, while the stream object (SOB) managed by the stream object information (SOBI) 89 is an object which is a digital broadcasting object and particularly of which contents of stream can not be analyzed. Therefore, regarding D_VOB, it is possible to detect the presentation time stamp (PTS) by analyzing the stream, and thus the time map can be created by using the presentation time stamp (PTS). On the contrary, regarding the stream object (SOB), it is not possible to analyze the stream and not to detect or identify the presentation time stamp (PTS), and thus the time map can not be generated by using the presentation time stamp (PTS). Therefore, according to the present invention, the time map to the stream object (SOB) is generated by using the arrival time stamp (ATS) instead of the presentation time stamp (PTS).

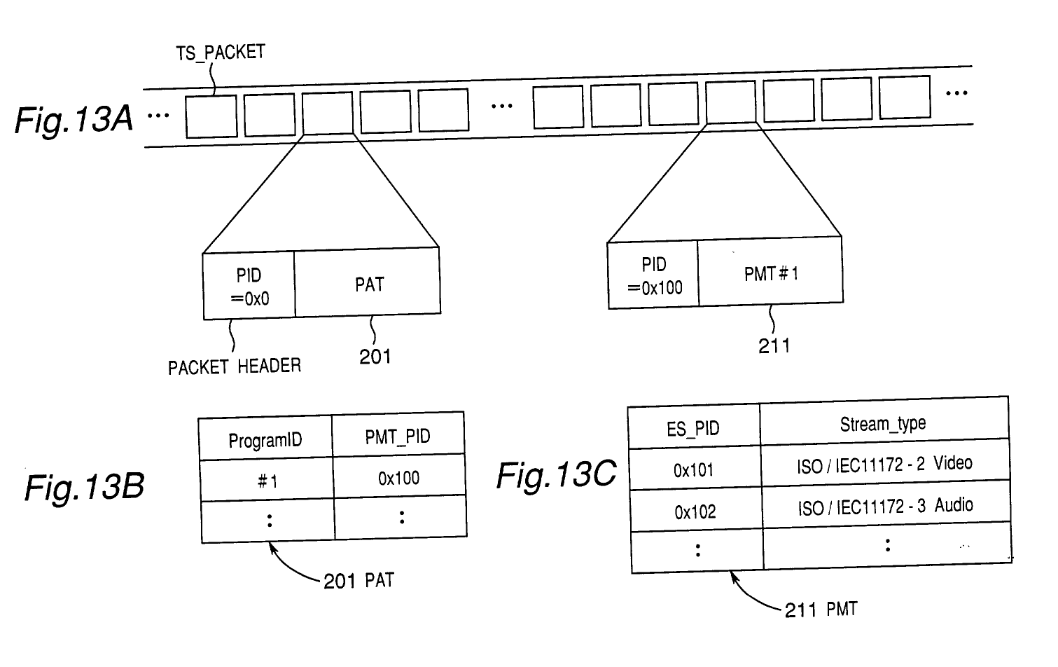

Analyzing and recording the stream mentioned above are described in detail below. The digital broadcasting stream encoded by MPEG-TS generally includes PAT (Program Association Table) 201 and PMT (Program Map Table) 211 indicating information relating to programs included in the stream, as shown in FIG. 13A. As shown in FIG. 13B, PAT 201 includes ID (Program ID) provided to each program included in the stream and PID (PMT_PID) of PMT indicating the data structures thereof. As shown in FIG. 13C, PMT 211 includes PID (ES_PID) of each elementary stream composing the program together with attribute information (Stream_type) thereof. According to the present invention, in order to record received digital broadcasting stream, PMT 211 of the digital broadcasting stream is analyzed, it is determined whether the attribute information of audio and video elementary streams can be identified or not, and then the stream is recorded according to the determination result.

When the determination the result is that the attribute information of the elementary streams can be identified, the presentation time stamp (PTS) of video and audio data included in the stream can be identified. In this time, the stream is recorded as D_VOB. The time map for D_VOB is generated according to the presentation time stamp (PTS).

Meanwhile, when the analyzing result of PMT 211, is that known attribute information of the audio and video elementary streams does not exist, the presentation time stamp (PTS) of video and audio data included in the stream can not be identified, and therefore the time map can not be generated according to the presentation time stamp (PTS) In this time, the stream is recorded as SOB. The time map is generated according to the packet arrival time stamp (ATS).

It is noted that in the digital broadcasting stream a plurality of programs may be multiplexed. In this case, there are a plurality of PMTs and a combination of a plurality of AV streams. In such a case, the time map according to the packet arrival time stamp may be generated and recorded as SOB.

(Correspondence Between Object Information and Cell Information)

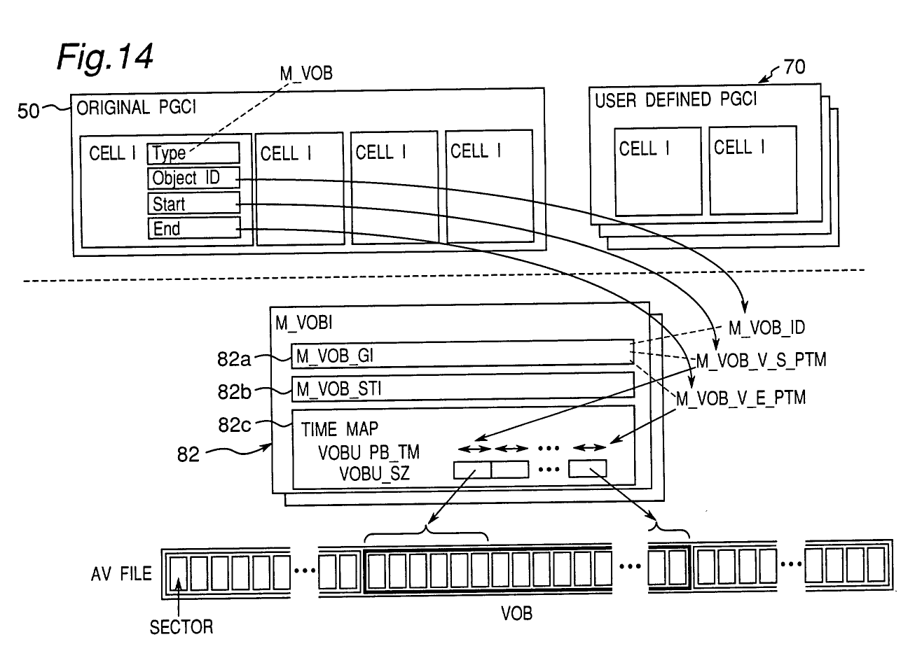

Referring next to FIG. 14, the movie object information (M_MOBI), which is one of the concrete forms of the object information (Object I), is taken as an example to see correspondence with the cell information.

When the type information (Type) specified in the cell information has the value “M_VOB”, this cell corresponds to a movie object. Likewise, when the type information has the value “D_VOB”, then the cell corresponds to a digital broadcasting object, and when the type information has the value “AOB”, then the cell corresponds to an audio object.

Based on the object ID (Object ID), the object information (VOBI) corresponding to the ID can be found. The object ID has a one-to-one correspondence to the movie object ID (M_VOB_ID) contained in the general information (M_VOB_GI) of the movie object information (M_VOB_I).

As described above, the object information corresponding to the cell information can be retrieved by using the type information (Type) and the object ID (Object ID).

The starting position information (Start) in the cell information corresponds to the start time information (M_VOB_V_S_PTM) of the movie object information. When the two values indicate a same time, it indicates that the cell is the first portion to be played of the movie object. On the other hand, when the starting position information (Start) has a value greater than that of the start time information (M_VOB_V_S_PTM), it indicates that the cell is to be played as a middle portion of the movie object. In such a case, the playback of the cell is delayed from the top of the object by the difference (time difference) between the start time information (M_VOB_V_S_PTM) and the starting position information (Start). The same relationship exists between the cell ending position information (End) and the end time information (M_VOB_V_E_PTM) of the movie object.

As described above, playback starting and the ending of a given cell can be obtained as relative points of time within the object by using the starting information (Start) and the ending information respectively in the cell information, and the start time information (M_VOB_V_S_PTM) and end time information (M_VOB_V_E_PTM) respectively in the general information (M_VOB_GI) of the movie object information (M_VOBI).

The time map of the movie object is a table comprising a playback time and data size for each movie object unit (VOBU). By using the time map, the relative playback start time and the relative playback end time of a given cell within the movie object described above can be converted to address data.

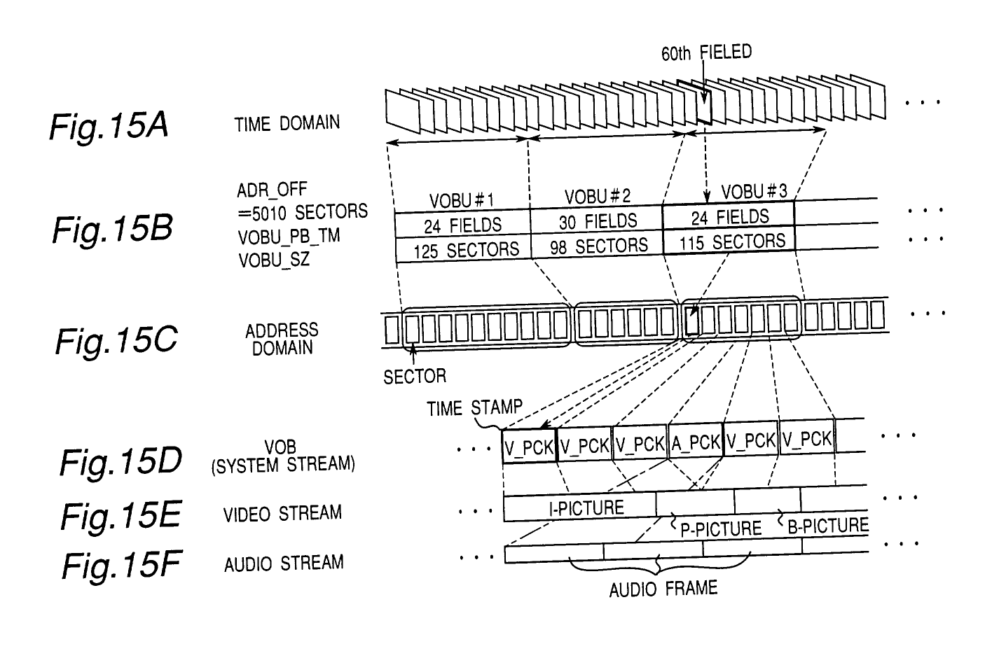

Now, the address conversion using the time map mentioned above will be specifically described with reference to FIGS. 15A to 15F.

FIG. 15A shows movie objects (M_VOB) representing video display on the time axis. FIG. 15B shows the time map comprising the length of playback time and the data size for each movie object unit (VOBU). FIG. 15C shows the movie object expressed on the data (sector series) axis. FIG. 15D shows pack series as an enlarged portion of the movie object. FIG. 15E shows a video stream. FIG. 15F shows an audio stream.

The movie object (M_VOB) is an MPEG program stream (MPEG-PS). In MPEG program stream, a video stream and an audio stream are assembled into a packet (PES packet), and a plurality of the packets (PES packets) are packed into a sequence. In the example, one pack contains one packet (PES packet), and a pack is allocated with one sector (=2048B) for easier access. Further, packed video packs (V_PCK) and audio packs (A_PCK) are multiplexed into a single stream. All of these are illustrated in FIG. 15C, 15D, 15E and 15F.

Further, an MPEG system stream (a general term for the program stream and transport stream) contains time stamps for synchronized playback of the multiplexed video and audio streams. The time stamp for the program stream is PTS (Presentation Time Stamp) which indicates the time when the frame is to be played. The movie object start time information (M_VOB_V_S_PTM) and the movie object end time information (M_VOB_V_E_PTM) mentioned earlier are time information obtained from the PTS. On the other hand, the time stamp for the transport stream is PCR (Program Clock Reference) which indicates the time of input of data to the buffer.

The movie object unit (VOBU) is described below. The movie object unit (VOBU) is the smallest access unit within the movie object (M_VOB). In order to accomplish highly efficient image compression, the MPEG video stream uses not only image compression using spatial frequency characteristics within a video frame but also image compression using motion characteristics between the frames, i.e. motion characteristics on the time axis. This means that expansion of a video frame requires information on the time axis, i.e. information about a future video frame or a past vide frame is required, or that the video frame may not be expanded by itself. In order to solve this problem, in MPEG video stream, a video frame (called I-picture) having no motion characteristics on the time axis is inserted every about 0.5 second, achieving higher random accessibility.

The movie object unit (VOBU) includes some packs from a pack containing the headmost data of an I-picture to a pack immediately before a pack containing the headmost data of the next I-picture. Thus, the time map comprises the data size (the number of packs) of each object unit (VOBU) and the playback time (the number of fields) of the video frames within the object unit (VOBU).

For example, an assumption is made that the value of Start in the cell differs from the value of start time information (M_VOB_V_S_PTM) of the movie object by one second (60 fields).

Now, the playback start time of each object unit in the movie object (M_VOB) can be obtained by accumulating the playback time (length) of each object unit (VOBU) in the time map from the first movie object. Likewise, the address of each object unit in the movie object (M_VOB) can be obtained by accumulating the data size (the number of packs) of each object unit from the first object unit.

According to the present embodiment, the first three object units (VOBU) of the movie object (M_VOB) have 24, 30 and 24 fields respectively. Thus, from the above calculation method, the video frame after one second (60 fields) from the top of the movie object (M_VOB) is found to be included in the third object unit (VOBU#3). Likewise, the start address of the third object unit (VOBU#3) is found to be the 223rd sector from the head of the object since these object units (VOBU) respectively have data sizes of 125, 98 and 115 sectors.

Adding the obtained address value to address value for 5010 sectors which is the M_VOB start address (ADD_OFF) within the AV file provides the start address of the data to be played.

In the above example, assumption is made that the video frame which is the 60th field from the top of the movie object (M_VOB) is to be played. As mentioned earlier however, the MPEG video does not allow decoding or playback from any one of all video frames. For this reason, the playback starts from the top of the object unit (VOBU) shifted by 6 fields away from the 60th field so that the playback starts from the I-picture. It should be noted that a playback can be started exactly from the video field specified by the cell by decoding the above 6 fields without displaying.

The method described above can also provide playback end time of the movie object corresponding to the end location in the cell information, and the address of the movie object in the AV file.

Next, the digital broadcasting object information (D_VOBI) will be described. The digital broadcasting object information is basically the same as the movie object information because the digital broadcasting object is a subclass derived from the object information. A big difference, however, is that the movie object (M_VOB) is created by recording an analog broadcasting. Specifically, while the movie object is an AV stream encoded by the recorder itself, the digital broadcasting object (D_VOB) is not an AV stream encoded by the recorder itself since in the digital broadcasting object data transmitted from a digital broadcast satellite is recorded directly.

More specifically, when encoding is made by the recorder, internal structure of the stream is clearly known; however, when the data is a result of direct recording, internal structure is not known unless the stream is not analyzed, and therefore it is impossible to make the time map.

It is possible to analyze the MPEG transport stream supplied through the digital satellite broadcast, As in the present embodiment, the time map may be created by using information within the MPEG transport stream. This method will be described below.

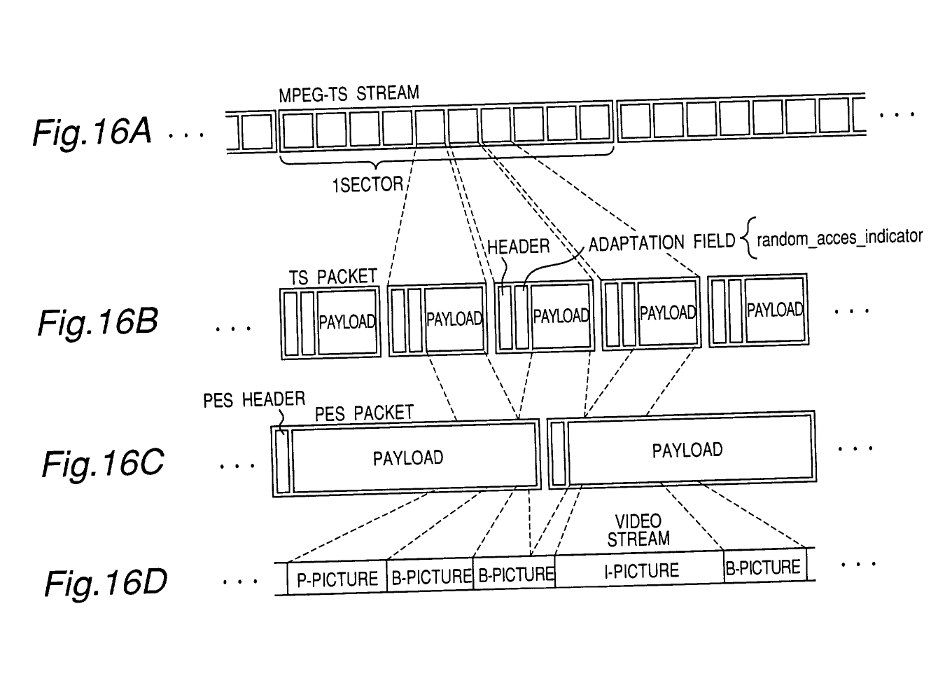

FIG. 16A shows an MPEG transport stream. FIG. 16B shows an enlarged view of transport packets. FIG. 16C shows PES packets. FIG. 16D shows a video stream.

As shown in FIG. 16A, the MPEG transport stream comprises a series of transport packets. The transport packet includes a header, an adaptation field, and a payload. The adaptation field includes a random access indicator (“random_access_indicator”). The random access indicator indicates that in this transport packet or the following transport packet (more precisely, the transport packet having the same program ID), a next PES packet (i.e. the PES packet in which the first byte of the PES packet appears first) contains an access point of the video stream or the audio stream. Particularly, for the video stream, this indicates that the I-picture is included.

This random access indicator can be used for determining the video object unit, and creating the time map.

The transport packet has a fixed size of 188 bytes. Therefore, a plurality of transport packets (2048 bytes/188 bytes=10 TS packets) are recorded in one sector of the DVD-RAM comprising 2048 bytes. While it is possible to handle as 1 pack=1 sector in the movie object (M_VOB), it is impossible in the digital broadcasting object (D_VOB). Data reading/writing in the DVD-RAM can only be made by the sector. Therefore even in the digital broadcasting object, information in the time map is made up of the playback time length of the movie object unit (VOBU) expressed in terms of the number of video fields, and the data size of the movie object unit expressed in terms of the number of sectors.

For the above reason, accuracy of the address is not secured in the time map when the movie object unit is defined to be from a transport packet to the next transport packet. Therefore, the movie object unit (VOBU) is defined by using the sector containing the transport packet.

A PROVIDER_INF field of the digital broadcasting object stream information (D_VOB_STI) includes an ID for identifying a broadcasting company and particular information related to each broadcasting company.

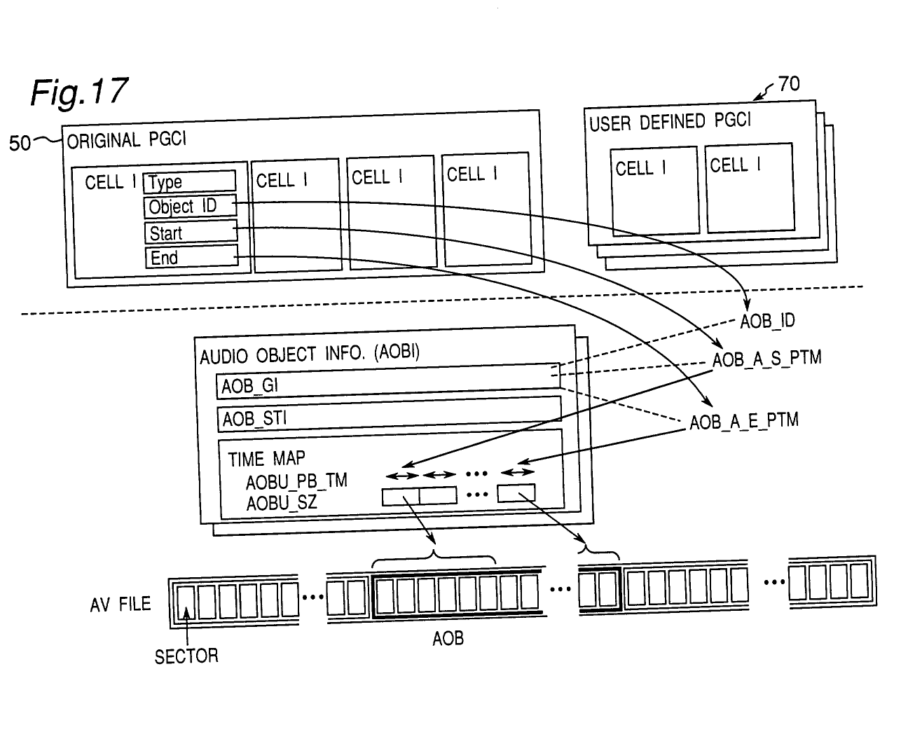

Referring now to FIG. 17, description will be made for the audio object information (AOBI). Again, as a subclass derived from the object information, the audio object information is basically the same as in the case of the movie object information. A big difference, however, is that the audio object is an object for the audio system only and is not formatted into the MPEG system stream. More details will be described here below.

Since the audio object is not formatted into the MPEG system stream, no time stamps are included in the audio object. Therefore, there is no reference time for indicating the playback start time or the playback end time of the cell or the object. Thus, the audio object start time (AOB_A_S_TM) in the audio object general information (AOBI_GI) is entered with 0, whereas the audio object end time (AOB_A_E_TM) is entered with the playback time length. Further, each of the Start field and the End field in the cell information is entered with relative time within the audio object.

Another difference of the audio data from the MPEG video data is that playback of the audio data can be started at any audio frame unit. Therefore, the audio object unit (AOBU) can be defined as the audio frame multiplied by any integer. If the audio object unit is too small, however, a huge amount of data must be handled in the time map. So, the audio object unit is made to be almost same length of the object unit of the movie object, which is about 0.5 second. The time map manages the playback time length and the data size for each audio object unit.

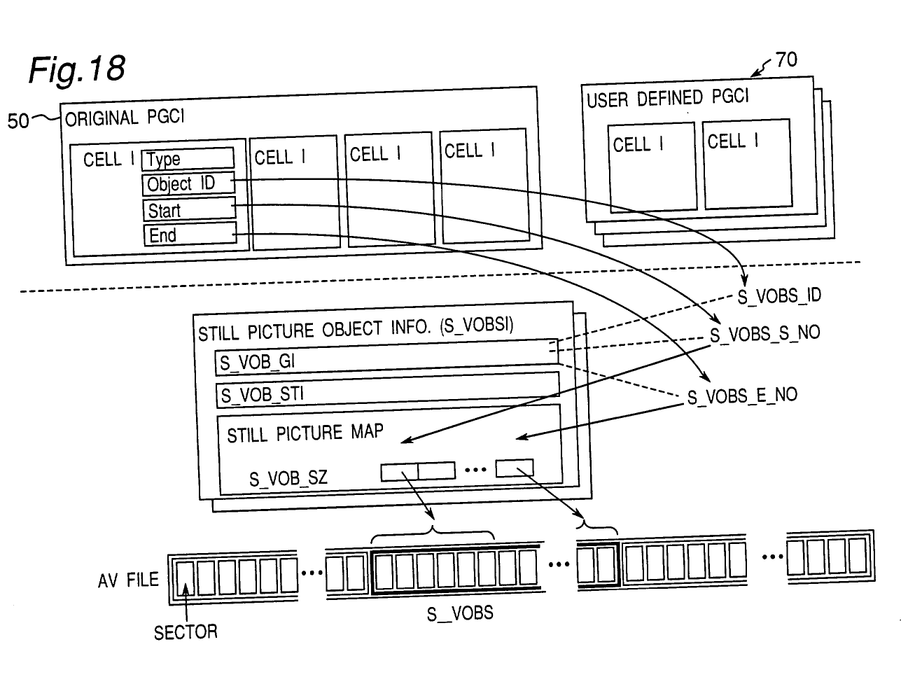

Referring now to FIG. 18, description will be made for the still picture object information (S_VOBSI) Again, as a subclass derived from the object information, the still picture object information (S_VOBSI) is basically the same as in the case of the movie object information. A big difference, however, is that the still picture object is an object including data of a plurality of sill pictures, and that the still picture object is not formatted into the MPEG system stream. More details will be described for the audio object information here below.

The still picture, differing from the movie or the sound, does not have time information. Thus, fields of the starting information and the ending information in the still picture object general information (S_VOBS_GI) are entered with a number representing the starting still picture (S_VOBS_S_NO) and a number representing the last still picture (S_VOBS_E_NO) respectively. Further, the Start field and the End field in the cell are entered with respective picture numbers within the still picture object instead of the time information.

The smallest access unit in still picture group is the frame of still picture. Thus, the still picture group map (S map) is defined as the time map, which is a table containing the data size (S_VOB_SZ) of each still picture.

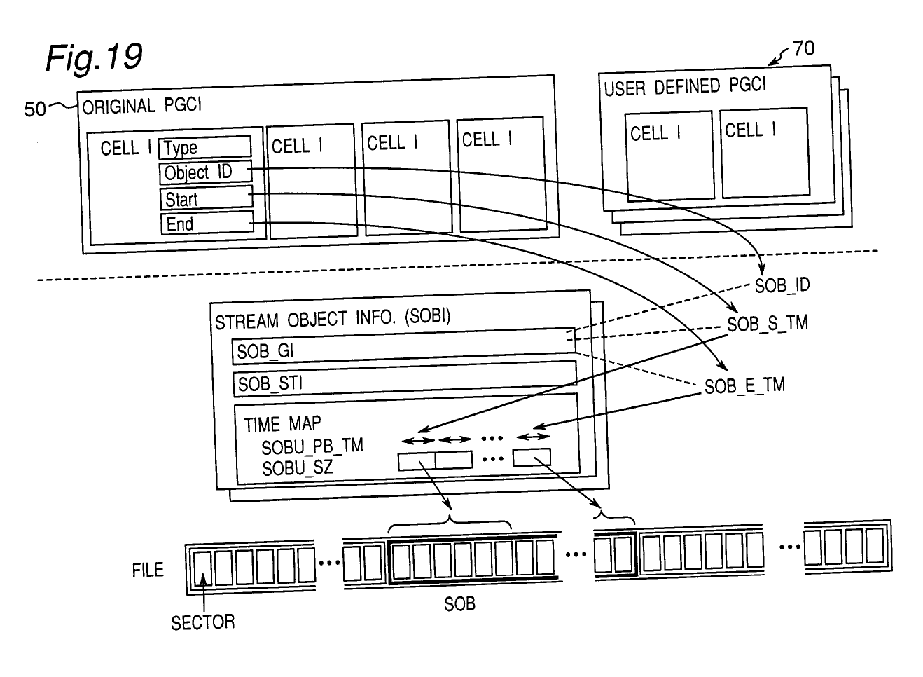

Referring to FIG. 19, description will be made for the stream object information (SOBI). Again, as a subclass derived from the object information, the stream object information is basically the same as in the case of the movie object information. The movie object (M_VOB) is an AV stream which is generated by recording analog broadcasting, that is, an AV stream which the recorder encodes by itself. On the contrary, the stream object is generated by recording directly data transferred in the digital broadcasting, and thus the stream object is not a stream which the recorder encodes by itself.

AS described above, the stream object (SOB) is different from the digital broadcasting object (D_VOB) in that the stream object has MPEG-TS format but does not have elementally streams which the recorder can recognize. In this case, since the content of the stream can not be analyzed, the presentation time stamp (PTS) of the AV data can not be identified and the time map according to the presentation time stamp (PTS) can not be generated. Since the stream object (SOB) can not recognize the playback time information such as PTS, in the stream object information (SOBI), a time (ATS: Arrival Time Stamp) at which TS packet arrives at the recorder is used as a reference time. Therefore, the start time (SOB_S_TM) in the general information of the container information is set to 0, and the end time (SOB_E_TM) is set to the arrival time stamp (ATS) of the last TS packet. Further, a relative time in the stream object is set to the start and end fields in the cell.

The stream object unit (SOBU) is obtained by dividing and aligning the stream object by a suitable time interval on a TS packet. The time map manages an elapsed time (SOBU_PB_TM) which uses as a time axis the arrival time stamp (ATS) of TS packet of the stream object unit, and a data size (SOBU_SZ).

By abstracting in advance the information for managing the AV streams, it becomes possible to define the playback control information such as the PGC information and cell information without depending on the information peculiar to a given AV stream format, making possible to integrally manage AV streams. Thus, environment can be realized in which users can play AV data without paying attention to the AV format.

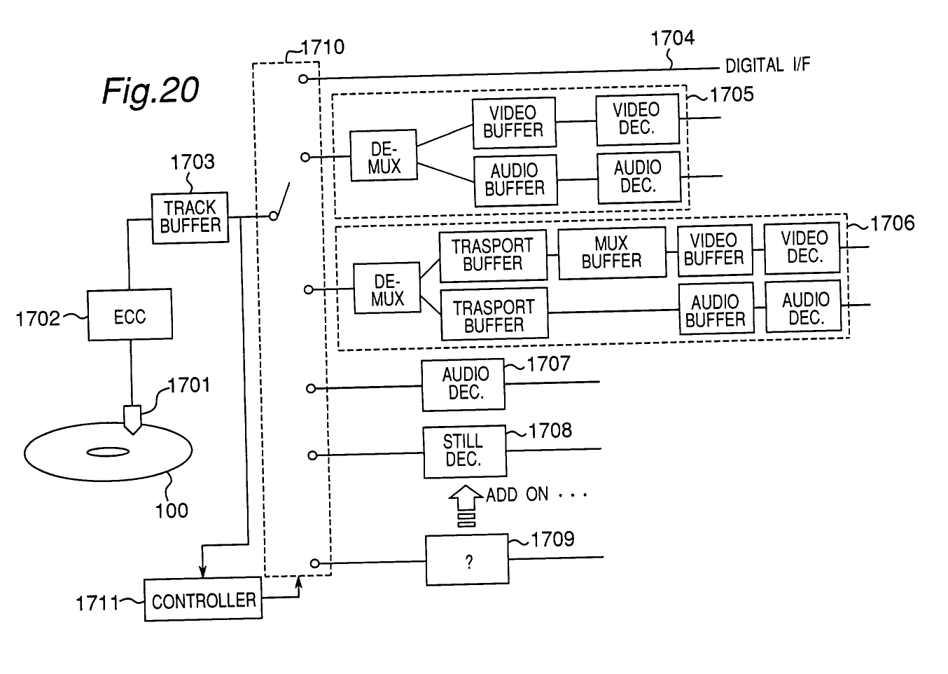

Further by using the above-described data structure, a new AV format can be easily incorporated into the data structure in DVD-RAM by simply defining the management information derived from the object information in the same manner as the other existing AV formats. (Player Model) Referring now to FIG. 20, a player model for playing the above optical disc is described. As shown in FIG. 20, the player comprises a pickup 1701, an ECC processor 1702, a track buffer 1703, a PS decoder 1705, a TS decoder 1706, an audio decoder 1707, a still picture decoder 1708, a switch 1710 and a controller 1711. The optical pickup 1701 reads out data from the optical disc 100. The ECC processor 1702 performs error correction and other operations to the read data. The track buffer 1703 tentatively stores the data after the error correction. The PS decoder 1705 decodes to play program streams such as the movie object (M_VOB). The TS decoder 1706 decodes to play transport streams such as the digital broadcast object (D_VOB). The audio decoder 1707 decodes to play the audio object (AOB). The still picture decoder 1708 decodes to play the still picture object. The switch 1708 switches among the decoders 1705, 1706, for entry of data. The controller 1711 controls each component of the player.

The data recorded on the optical disc 100 is read by the pickup 1701, goes through the ECC processor 1702, and stored in the track buffer 1703. The data stored in the track buffer 1703 is then entered into one of the decoders 1705, 1706, 1707 and 1708, and then decoded to be outputted therefrom. In this switching operation, the controller 1711 checks the read data and sees the type information of the cell information in the PGC information providing the playback sequence according to the method described earlier. The switch 1710 is controlled to switch according to the type information so that the read information is sent to an appropriate decoder.

The player of the present embodiment further comprises a digital interface 1704 for supplying the stored data to external equipment. Through this interface with an appropriate communication protocol such as IEEE1394 and IEC958, the stored data can be fed to the external equipment. This is especially advantageous when data having a format which the player can not treat like the stream object (SOB) or a program of a new AV format is outputted through the digital interface 1704 to be played in the external AV equipment, without using the decoders in this player.

On the other hand, to support a new AV format in this player, a new decoder 1709 adapting to the new AV format may be coupled to the track buffer 1703 in the same way as the other existing decoders 1705-1708.

(Recording Operation by DVD Recorder)

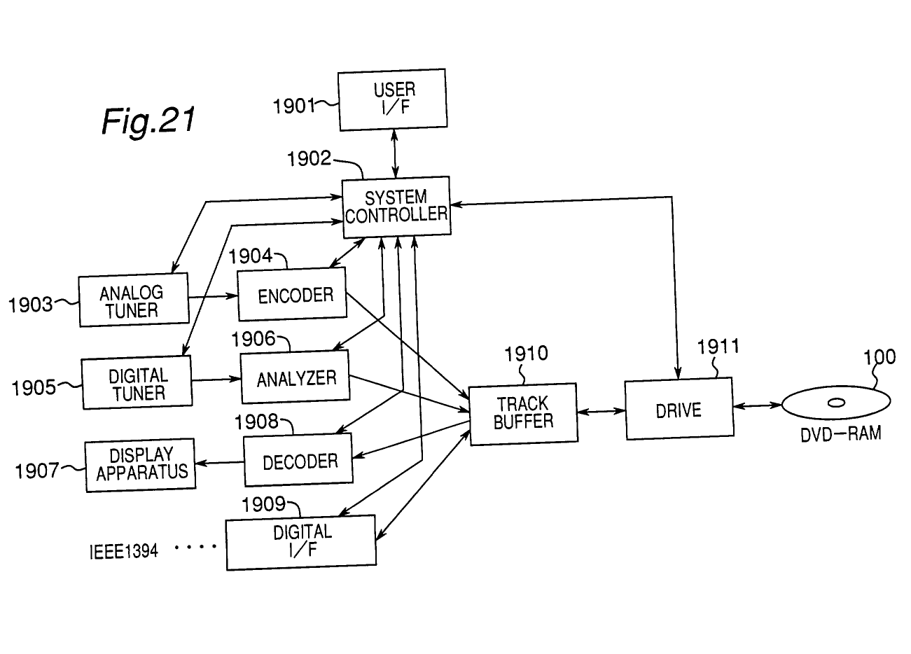

Next, reference is made to FIG. 21 to describe structure and operation of a DVD recorder according to the present invention for playing (reproducing)/recording the above optical disc.

As shown in the figure, the DVD recorder comprises a user interface 1901, a system controller 1902, an analog tuner 1903, an encoder 1904, a digital tuner 1905, an analyzer 1906, a display apparatus 1907, and a decoder 1908. The user interface 1901 provides a display for the user and receives requests from the user. The system controller 1902 manages and controls overall of the DVD recorder. The analog tuner 1903 receives VHF and UHF waves. The encoder 1904 converts analog signals into digital signals to encode the digital signal into an MPEG program stream. The digital tuner 1905 receives a digital broadcasting. The analyzer 1906 analyzes an MPEG transport stream sent from the digital broadcast satellite. The display apparatus 1907 includes a TV monitor and speaker system. The decoder 1908 decodes the AV streams. The decoder 1908 includes PS decoder and TS decoder shown in FIG. 18. The DVD recorder further comprises a digital interface 1909, a track buffer 1910 for temporary storage of the data to be written, and a drive 1911 for writing data on the DVD-RAM 100. The digital interface 1909 is an interface for outputting to external equipment through such a protocol as IEEE1394.

In the DVD recorder having the above configuration, the user interface portion 1901 first receives demand from the user. The user interface 1901 transmits a request from the user to the system controller 1902. The system controller 1902 interprets the request into commands to send to appropriate modules. When the request from the user is to record an analog broadcasting program, the system controller 1902 requests the tuner 1903 to receive the program, and the encoder 1904 to encode.

The encoder 1904 performs video encoding, audio encoding and system encoding on the AV data received from the analog tuner 1903 to output the encoded data to the track buffer 1910.

The encoder 1904, upon commencing the encoding operation, sends the playback start time (M_VOB_V_S_PTM) of the MPEG program stream encoded to the system controller 1902, and then in parallel with the encoding operation, sends the time length and size information of the movie object unit (VOBU) to the system controller 1902 as source information for creating the time map.

Next, the system controller 1902 issues a recording request to the drive 1911, so that the drive 1911 takes data stored in the track buffer 1910 and records this information on the DVD-RAM disc 100. At that time, the system controller 1902 instructs the drive 1911 where to store the information on the disc 100 according to the allocation information of the file system.

Ending of the recording operation is demanded by the user through a stop request. The stop request from the user is transmitted through the user interface 1901 to the system controller 1902. The system controller 1902 then issues the stop request to the analog tuner 1903 and the encoder 1904.

Upon reception of the stop request from the system controller 1902, the encoder stops the encoding operation, and sends the playback stop time (M_VOB_V_E_PTM) of the last encoded MPEG program stream to the system controller 1902.

After the encoding operation is over, the system controller 1902 creates the movie object information (M_VOBI) based on the information received from the encoder 1904. Next, the system controller 1902 creates the cell information corresponding to the movie objet information (M_VOBI). The important point here is that the type information in the cell information must be specified as “M_VOB”. As described earlier, the information in the cell information is configured without depending on the movie object (M_VOB), and all information which depends on the movie object (M_VOB) is concealed into the movie object information (M_VOBI). Therefore, an error in recognizing the type information in the cell information will lead to inability to perform normal playback, possibly resulting in system down.

Finally, the system controller 1902 requests the drive 1911 to finish recording the data stored in the track buffer 1910, and to record the movie object information (M_VOBI) and cell information. The drive 1911 records the data remaining in the track buffer 1910, the movie object information (M_VOBI) and the cell information on the DVD-RAM, subsequently completing the recording operation.

Next, description will be made in a case of the user's request for recording a digital broadcast program.

The user's request for recording the digital broadcasting program is transmitted through the user interface 1901 to the system controller 1902. The system controller 1902 then requests the digital tuner 1905 to record, and the analyzer 1906 to analyze received data.

An MPEG transport stream sent from the digital tuner 1905 is sent through the analyzer 1906 to the track buffer 1910. The analyzer 1906 first picks up from the MPEG transport stream the start time information (D_VOB_V_S_PTM) as information necessary for generating the digital broadcasting object information (D_VOBI), and sends this information to the system controller 1902. Next, the analyzer 1906 determines the movie object unit (VOBU) in the MPEG transport stream, and sends the time length and size of the movie object unit as information necessary for creating the time map to the system controller 1902. It should be noted that the movie object unit (VOBU) can be determined, as described earlier, based on the random access indicator (random_access_indicator) in the application field contained in the TS packet header.

Next, the system controller 1902 outputs a recording request to the drive 1911. Then the drive 1911 picks up the data stored in the track buffer 1910 and records the data in the DVD-RAM disc 100. At this time, the system controller 1902 also informs the drive 1911 where the drive 1911 should record the information on the disc 100, based on allocation information of the file system.

Ending of the recording operation is instructed by the user through a stop request. The stop request from the user is transmitted through the user interface 1901 to the system controller 1902. The system controller 1902 then issues the stop request to the digital tuner 1905 and the analyzer 1906.

The analyzer 1906, upon reception of the stop request from the system controller 1902, stops the analyzing operation, and sends the display end time (D_VOB_V_E_PTM) of the movie object unit (VOBU) of the last analyzed MPEG transport stream to the system controller 1902.

After the completion of receiving the digital broadcasting, the system controller 1902 creates the digital broadcasting object information (D_VOBI) based on the information received from the analyzer 1906, and next, creates the cell information corresponding to the digital broadcasting objet information (D_VOBI), at which time the type information in the cell information is specified as “D_VOB”.

Finally, the system controller 1902 requests the drive 1911 to finish recording the data stored in the track buffer 1910, and to record the digital broadcasting object information and cell information. The drive 1911 records the data remaining in the track buffer 1910, the digital broadcasting object information (D_VOBI) and the cell information on the DVD-RAM disc 100, completing the recording operation.

The above description is made on the basis that the user makes request to start and stop recording. When a timer recording function commonly provided in a VTR system is used, the system controller automatically issues recording start and stop commands in stead of user's request, and thus the steps of operation performed by the DVD recorder are essentially the same.

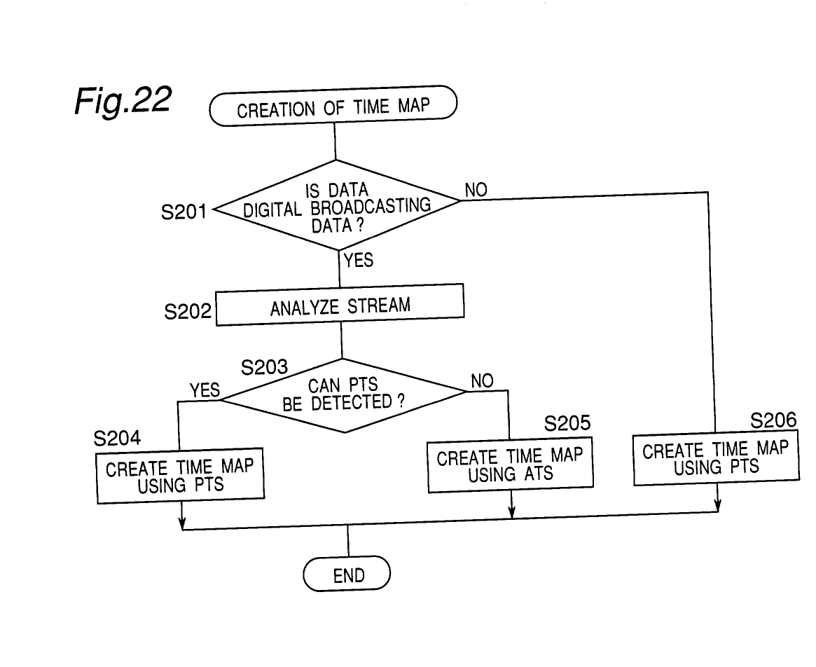

Next, creation process of the time map in the object information (Object I) at the object recording is described below. FIG. 22 is a flowchart of the creation process of the time map. This process is executed by a system controller 1902. At recording the object, the type of the object is first determined (S201). When the object type is “digital broadcasting data”, the stream is analyzed (S202). If the stream can be analyzed and PTS can be detected (“Yes” in S203), the time map using PTS is created (S204). In this case, the stream is recorded as a digital broadcasting object (D_VOB). Meanwhile, if the stream can not be analyzed and PTS can not be detected (“No” in S203), the time map using ATS is created (S205). In this case, the stream is recorded as a stream object (SOB). When the object type is not “digital broadcasting data”, the time map using PTS is created (S206). The detail of the time map creation process will be described later.

(Playback Operation by DVD Recorder)

Next, playback operation in the DVD recorder will be described.

First, the user interface 1901 receives a request from the user. The user interface 1901 transmits the request to the system controller 1902. The system controller 1902 interprets the user's request to commands to send them to appropriate modules. For example, when the use's request demands playback of a PGC information, the system controller 1902 analyzes the PGC information and cell information to see which object should be played. Description will be made below for a case in which an original PGC comprising one movie object (M_VOB) and one cell information is played.

The system controller 1902 first analyzes the type information stored in the cell information in the PGC information. When the type information is “M_VOB”, it means that the AV stream to be played is the stream recorded as the MPEG program stream. Next, the system controller 1902 refers to the ID of the cell information to find the corresponding movie object information (M_VOBI) from the table (M_AVFIT). The system controller 1902 then finds start address and end address of the AV data to be played according to the start time information (M_VOB_V_S_PTM) and end time information (M_VOB_V_E_PTM) contained in the movie object information, and time map. At this time, the system controller 1902 determines the type of the object to be played, recognizes that a time map corresponding to the object is whether a time map with PTS correlated to address or a time map with ATS correlated to address, and obtains a read address by referring to the time map and using the time axis (ATS or PTS) according to the kind of the time map.

Next, the system controller 1902 sends to the drive 1911 a request for reading from DVD-RAM 100, together with the start address of the reading. The drive 1911 then reads out AV data from the address given by the system controller 1902, and stores the read data to the track buffer 1910.

Next, the system controller 1902 sends to the decoder 1908 a decoding request of the MPEG program stream. The decoder 1908 then read out the AV data stored in the track buffer 1910 to decode the read data. The decoded AV data is outputted through the display apparatus 1907.

On the completion of reading all the data instructed by the system controller 1902, the drive 1911 reports to the system controller 1902 that the reading operation is completed. The system controller 1902 then issues a command to the decoder 1908 to stop the playback operation. The decoder 1908 continues to decode data until the track buffer 1910 is emptied. After all the data is decoded and played, the decoder 1908 reports to the system controller 1902 that the replay operation is finished, then bringing the playback operation to a complete end.

The above description was made for the case in which one original PGC containing one movie object (M_VOB) and one cell information is to be played. However, the playback operation of the AV stream can be performed by the same steps of operation whether the original PGC contains only one digital broadcasting object (D_VOB), contains a plurality of movie objects, contains a plurality of digital broadcasting objects, or contains both movie objects and digital broadcasting object. Further, the same goes with a case in which the original PGC contains a plurality of cells, or in a case of the user-defined PGC.

Further, the audio object (AOB) and other AV stream, i.e. the still picture object (S_VOBS) are handled essentially in the same procedures by the same modules, differing only in the configuration within the decoder 1908. In these cases, the decoder 1908 may be configured by the PS decoder 1705, the TS decoder 1706, the audio decoder 1707, or the still picture decoder 1708 as shown in FIG. 20.

Next, an example is taken for a case in which the decoder 1908 does not have capabilities for playing all kinds of the AV streams.

If the decoder 1908 does not have playback capability for the MPEG transport stream, playback operation by the decoder 1908 is impossible as described above. In such a case the digital interface portion 1909 is used to supply external equipment with the data, so that the data can be played by the external equipment.

When the system controller 1902 finds from the cell information in the PGC information that the user requests playback of a digital broadcasting object (D_VOB) not supported by the system, the system controller 1902 requests the digital interface 1909 for external output instead of requesting the decoder 1908 for playback. The digital interface 1909 transmits AV data stored in the track buffer 1910 in accordance with the communication protocol of the connected digital interface. Other operations performed are the same as those performed when the movie object (M_VOB) is played.

A judgment must be made whether or not the decoder 1908 is compatible with the AV stream requested for replay. This judgment may be made by the system controller 1902 by itself, or the system controller 1902 may ask the decoder 1908.

(DVD Player)

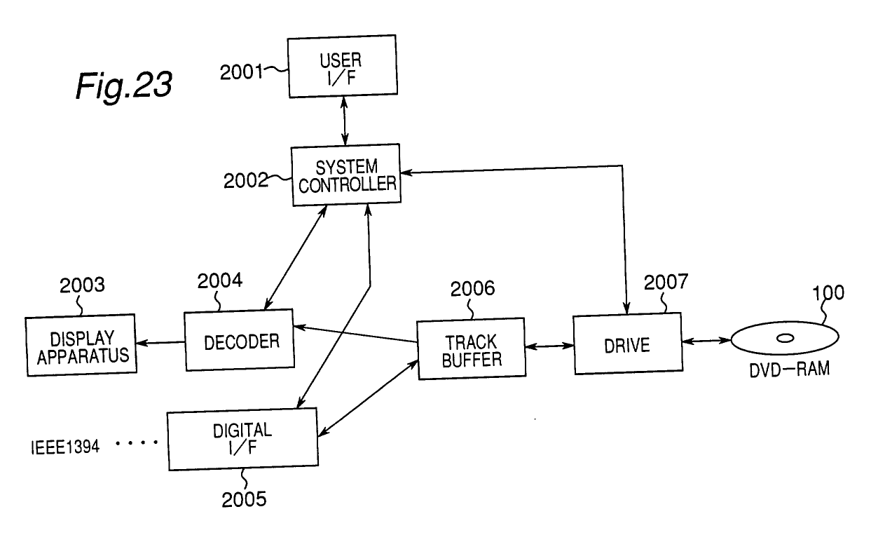

Next, with reference to FIG. 23, a DVD player according to the present invention is described. The DVD player is a realization of the player model described above to play the above optical disc.

As shown in the figure, the DVD player comprises a user interface 2001, a system controller 2002, a display apparatus 2003, a decoder 2004, a digital interface 2005, a track buffer 2006 and a drive 2007. The user interface 2001 receives requests from the user and displays some indications to the user. The system controller 2002 manages and controls overall of the DVD player. The display apparatus 2003 includes a TV monitor and speaker system. The decoder 2004 decodes the MPEG stream. The digital interface 2005 connects to IEEE1394 and so on. The track buffer 2006 temporally stores the data read from the DVD-RAM 100. The drive 2007 reads data out from the DVDRAM 100. The DVD player configured as above performs the same playback operations as in the DVD recorder described earlier.

It should be noted that the DVD-RAM is taken as an example in the present embodiment. However, the same description so far has been made applies to other media. The present invention should not be limited to such media as the DVD-RAM and other optical discs.

Further, according to the present embodiment, the AV stream not supported by the decoder is played through the digital interface. However, those AV streams which are supported by the decoder may be outputted to external equipment through the digital interface depending on the request from the user.

Further, according to the present embodiment, the audio data and the still picture data were treated as unique data differing from the MPEG streams. However, these data may also be recorded in the format of MPEG system stream.

<Second Embodiment>

The second embodiment of the present invention will be described below by using a DVD recorder and a DVD-RAM as examples.

The basic structures and operations of the DVD recorder and the DVD-RAM according to the present embodiment are the same as those in the first embodiment, and therefore their description is omitted. In the following, particularly, description will be given to a structure of a time map for a digital broadcasting object (D_VOB) which is an object for a digital broadcast.

(PCR Map and PTS Map)

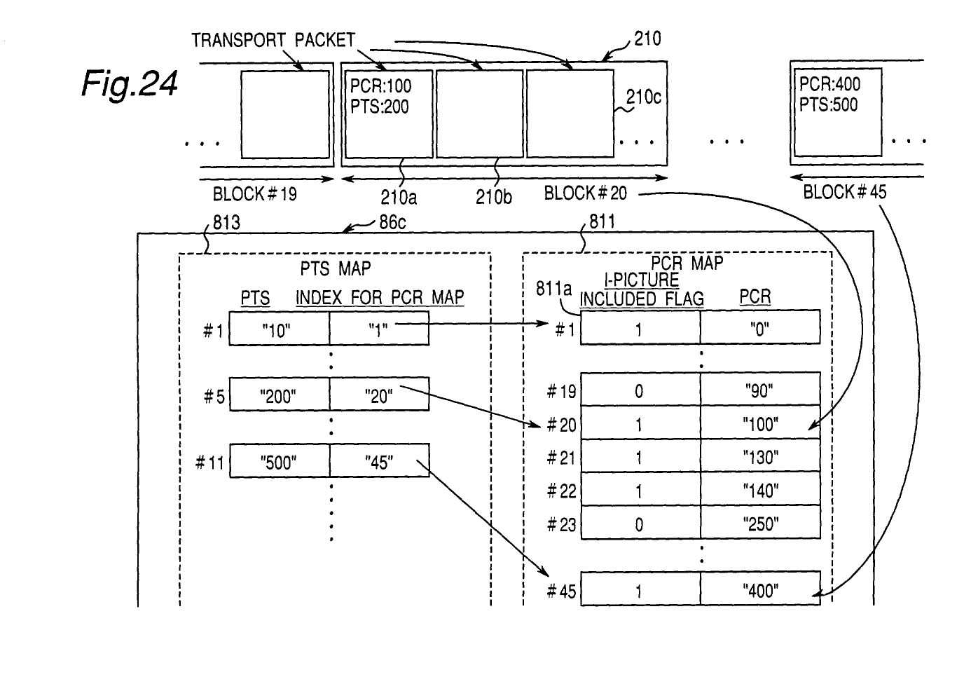

FIG. 24 shows the details of the time map according to the present embodiment. As shown in FIG. 24, a time map 86c is made of a two-hierarchy comprising a PCR map 811 and a PTS map 813.

When the digital broadcasting object (D_VOB) is to be recorded on a disc, a stream is recorded for each ECC block as a recording unit. More specifically, the stream recording is always started at a head sector in the ECC block.

The time map manages an object in a block unit collecting a predetermined number (N) of ECC blocks. In the following, a group of N blocks acting as the management unit of the time map will be simply referred to as a “block”. N is an integer of 1 or more and is fixed in the stream. One block includes a plurality of transport packets. In an example shown in FIG. 24, a 20th block 210 includes a plurality of transport packets 210a, 210b, 210c . . . .

The PCR map 811 is a table having an entry corresponding to a block, and, therefore, has the same number of entries as the blocks. The PCR map 811 manages, for each entry, a PCR (Program Clock Reference) given to the transport packet provided on the head of a block indicated by the entry, and an I-picture included flag 811a for the block. The PCR is information indicative of a time for input of the data to a decoder. The I-picture included flag serves to identify that the data of the I-picture (self-reproduceable picture) of MPEG video data are stored or not in the block. In the present embodiment, the I-picture included flag of “1” indicates that the block includes the I-picture. In the example shown in FIG. 24, a value (“100”) of the PCR given to the transport packet 210a on the head of the 20th block 210 are stored in the 20th entry of the PCR map 811, as well as the I-picture included flag (“1”) for the 20th block 210.

The PTS map 813 is a table for managing the value of PTS (Presentation Time Stamp) for each I-picture in the digital broadcasting objet (D_VOB). The PTS map 813 is comprised of the PTS value for each I-picture and an index indicative of a block number in which the I-picture is included. In the case where the I-picture is included in a plurality of blocks, only a number of a head block of them in which the I-picture is included is stored as the index. In FIG. 24, it is apparent from the PCR map 811 that the I-picture is stored from the 20th to 22nd blocks. In this case, the fifth entry of the PTS map 813 stores the head block number of “20” of a block group including the I-picture as the index for the PCR map together with a PTS value (“200”) in the head block.

As shown in FIG. 24, the PCR map 811 is a table having an entry for each block and the order of the entry in the PCR map 811 corresponds to a block number indicated by the entry. For this reason, the block number corresponding to the PTS value is designated by using the order of the PCR entry in the PCR map 811 in the index for the PCR map of the PTS map 813.

(Reproduction Using PCR Map/PTS Map)

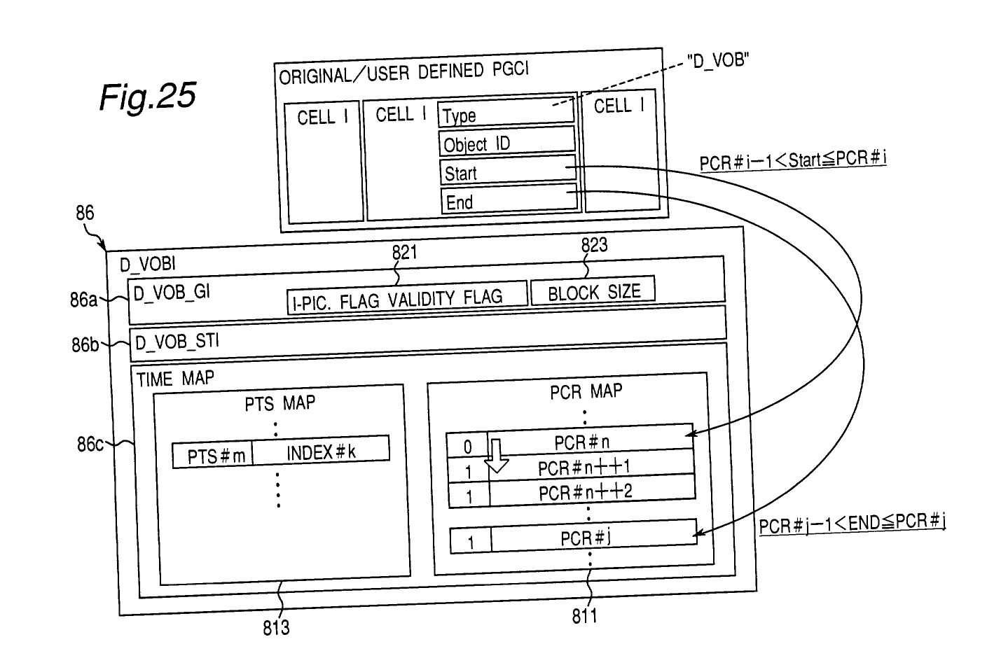

Referring to FIG. 25, next, description will be given to a method for reproducing a digital broadcasting object from PGC information using the PCR map 811 and the PTS map 813.

First of all, the structure of D_VOBI will be described. The basic structure of the D_VOBI is the same as in the first embodiment. Therefore, the differences between the present embodiment and the first embodiment will be described below.

In FIG. 25, digital broadcasting object general information (D_VOB_GI) 86a has an I-picture flag validity flag 821 and block size information (“Block size”) 823. The I-picture flag validity flag 821 indicates the validity of the I-picture included flag in each PCR entry described above. The block size information 823 indicates the size of the block comprising the number N of ECCs described above.

Thus, the I-picture flag validity flag 821 for identifying the validity of the I-picture included flag is provided for the following reason. When a transport stream cannot be analyzed and is recorded without identification of I-pictures, the validity of the I-picture included flag should be previously decided in order not to erroneously recognize the I-picture included flag during the reproducing operation.

Next, the procedure for reproducing the digital broadcasting object will be described.

The structures of PGC information (PGCI) and cell information (CellI) are the same as those in the first embodiment. Start position information (Start) and end position information (End) of the digital broadcasting object which are stored in the cell information indicate the value of a PCR in the transport stream.

In the case where the digital broadcasting object is to be reproduced, a position at which the digital broadcasting object is to be read out is determined based on the start position information (Start) stored in the cell information in the following manner. When the cell information is stored in user-defined PGC information, the start position information indicates a start time which is optionally designated by a user and the reading is performed with a random access.

First of all, the time stored in the start position information (Start) is compared with each PCR value stored in the PCR map 811, thereby detecting an ith entry in the PCR map which satisfies the following condition.

PCR #i−1≦Start≦PCR#i (1)

“PCR #x” provided herein represents a PCR of the xth entry. “entry #x” represents the xth entry in the following. As described above, moreover, referring to the PCR value to obtain the entry of the map corresponding to the start position information (Start) is also referred to as “mapping”.

Next, the I-picture flag validity flag 821 of the digital broadcasting object information (D_VOB_GI) is checked. When the flag 821 indicates “valid”, the I-picture included flag of the entry #i of the PCR is checked. When the block does not include the I-picture (that is, the value of the flag is “0”), the next PCR entry, that is, a PCR entry #i+1 is checked in the same manner. Subsequently, the search is continued in a backward direction (a proceeding direction) until the head block including the I-picture is found.

When the I-picture included flag of the PCR entry #i which has been first checked indicates that the block includes the I-picture (that is, the value of the flag is “1”), the search is continued in a direction toward a PCR entry #i−1 which is the PCR entry, that is, a forward direction (a reverse direction) until the PCR entry of the head of the I-picture is found. A block indicated by the PCR entry retrieved in the above-mentioned manner acts as a reproducing start block.

Next, a time designated by the end position information (End) in the cell information is compared with each PCR value stored in the PCR map 811, thereby detecting an entry #j of the PCR map which satisfies the following condition. Consequently, the reproducing end block can be specified.

PCR #j−1≦End≦PCR #j (2)

The reproducing start block and the reproducing end block which are obtained in the above-mentioned manner are converted into address information of the digital broadcasting object (D_VOB) by using the block size information 823 of the general information of the digital broadcasting object (D_VOB_GI), and, furthermore, are converted into address information in a file in which the digital broadcasting object is stored. Then, data is read out from the file by using the address information to be decoded and reproduced.

In the PTS map 813, moreover, an entry indicative of the reproducing start block obtained by the PCR map 811 is retrieved by relating the entry of the PCR map 811 to that of the PTS map 813 through an index. By giving, as a display start time, the PTS value obtained by the retrieval in the PTS map 813 to the decoder, the decoder can control an input stream such that the data is not displayed before the time indicated by the PTS.

As described above, random access reproduction for the recorded digital broadcasting object can be performed in an optical disc according to the present embodiment.

(Special Reproducing Operation)

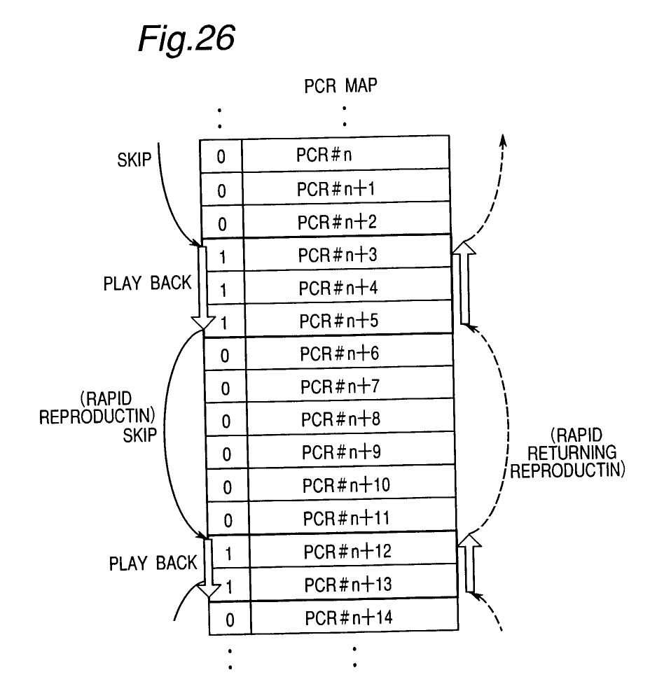

Next, a process for special reproduction, that is, rapid feeding reproduction will be described with reference to FIG. 26.

The special reproduction is performed by referring to the above-mentioned I-picture included flag. The I-picture has a maximum size of 224 KB. Therefore, the I-picture is generally divided into a plurality of blocks to be recorded. Accordingly, a PCR entry continuously having a value of the I-picture included flag of ON (that is, “1”) is set to one unit and the special reproduction is performed for each unit.

As shown in FIG. 26, for example, it is assumed that the I-picture included flag is set for each PCR entry. In this case, a PCR entry #n+3 to a PCR entry #n+5 in which the I-picture included flag is continuously ON are set to a reproduction unit of the I-picture and data corresponding to these entries are read out from the file in order to be decoded and reproduced. When each of the blocks corresponding to the PCR entries #n+3 to #n+5 is completely read out, the process skips to an entry #n+12 in which the I-picture included flag is ON in order to perform the reproduction of the next I-picture. By repeating the above-mentioned process, the special reproduction, that is, the rapid feeding reproduction can be performed. Moreover, rapid returning reproduction can be performed by skipping the reproduction unit of the I-picture in a reverse direction.

(Deleting Operation)

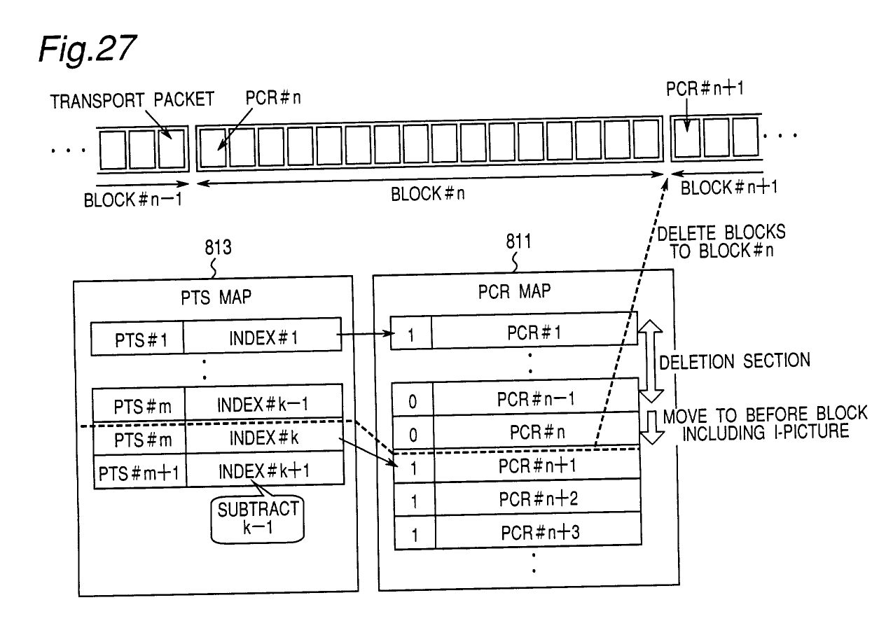

Next, an deleting operation will be described with reference to FIG. 27.

A method for detecting an deleting section is basically the same as the process for reproduction. More specifically, PCR entries corresponding to a start position and an end position which are designated by a user are obtained, and the I-picture included flag of the entry at an deleting start position is checked. It should be noted that a block including the head of the I-picture is not an deleting start block but a block just after the block is the deleting start block.

The reason is as follows. The last data of a previous GOP (Group of Pictures) are also stored together in the block including the head of the I-picture. Therefore, if the block including the head of the I-picture is deleted, the GOP just before cannot normally be reproduced to the end.

For the deleting operation, moreover, the same process as in a start block is carried out for an deleting end block. In FIG. 27, when the I-picture included flag of the entry #n−1 which is the deleting end position designated by the user is ON, a retrieval is further carried out until an entry of which the I-picture included flag is ON is retrieved in a proceeding direction, that is, a next entry direction. When the entry with the I-picture included flag of “ON” is detected, a block indicated by an entry just before the detected entry is set to the deleting end block. In the example of FIG. 27, the PCR entry with the first I-picture included flag of ON after the entry #n−1 is the entry #n+1. Therefore, a block corresponding to the PCR entry #n just before the entry #n+1 is set to the deleting end block. More specifically, each of the blocks corresponding to the PCR entries from #1 to #n is deleted.

Conversely, in the case where the I-picture included flag of the entry #n−1 designated by the user as the deleting end position is ON, the retrieval is carried out in a reverse direction to detect a PCR entry with the I-picture included flag of OFF. When the first PCR entry with the I-picture included flag of OFF is found, the block corresponding to the found PCR entry is set to the deleting end block.

After the above-mentioned process, the data from the deleting start block to the deleting end block are deleted and the PCR entries corresponding to these blocks in the PCR map 811 are deleted.

As shown in FIG. 27, moreover, the PTS entry of the PTS map 813 indicative of the PCR entry deleted in the PCR map is also deleted, and index numbers in the remaining PTS entries are subtracted by the number of the PTS entries deleted in the forward portion respectively.

In the case where only the intermediate portion of the digital broadcasting object (D_VOB) is to be deleted, that is, the deleting is performed leaving front portion and rear portion of the digital broadcasting object, the entry of an deleting section is deleted for the PCR and PTS maps corresponding to the digital broadcasting object remaining in the front portion. The index number of the PTS entry is modified in addition to the deletion of the entry corresponding to the deleted block as described above for the PCR and PTS maps corresponding to the digital broadcasting object remaining in the rear portion.

(Multistream)

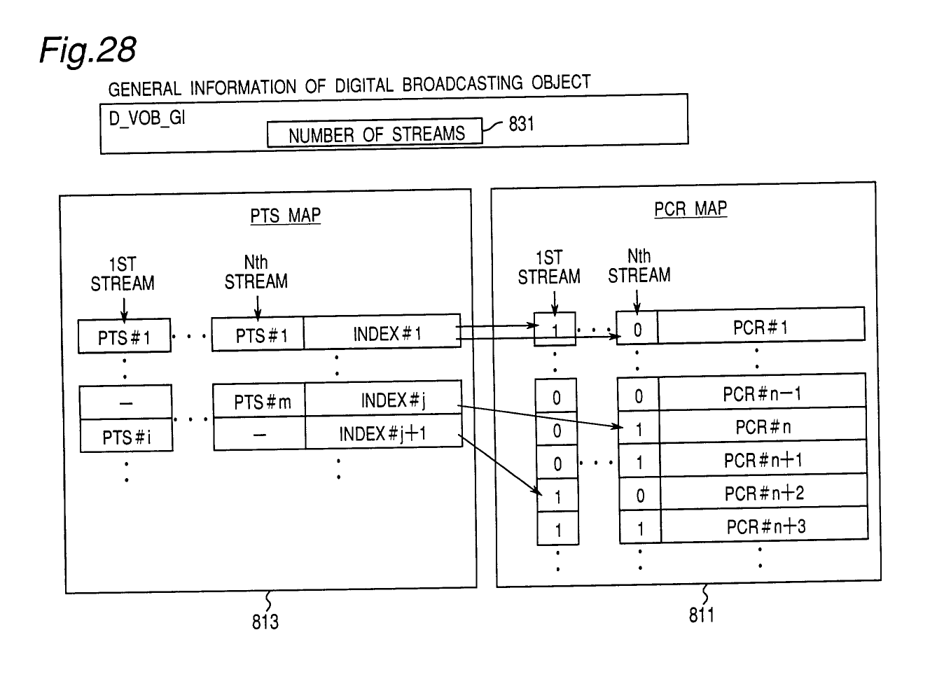

Next, the case of a multistream will be described with reference to FIG. 28.

It is possible to simultaneously multiplex a plurality of video streams to the transport stream of an MPEG. In the case where there are N video streams, the number of video streams (Number_of_Streams) 831 is described in the general information of the digital broadcasting object (D_VOB_GI) as shown in FIG. 28, for example.

In the PCR map 811, moreover, the field of the I-picture included flag in the PCR entry is extended corresponding to the N streams, respectively. Also in the PTS map 813, similarly, the PTS field of the I-picture in the PTS entry is extended for the N streams.

(Recorder)

The structure and basic operation of a recorder is almost the same as the structure and basic operation described in the first embodiment.

In the present embodiment, particularly, an analyzing section 1906 serves to create the PCR map and PTS map. In the case where the recorder has no capability of creating the PTS map, that is, of analyzing the video data of the MPEG stream, all the I-picture included flags in the PCR entry are set to 0 and the I-picture flag validity flag in the D_VOB_GI is turned OFF (“invalid”).

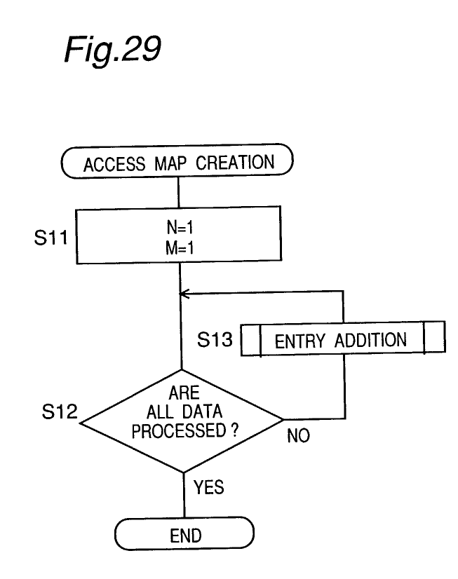

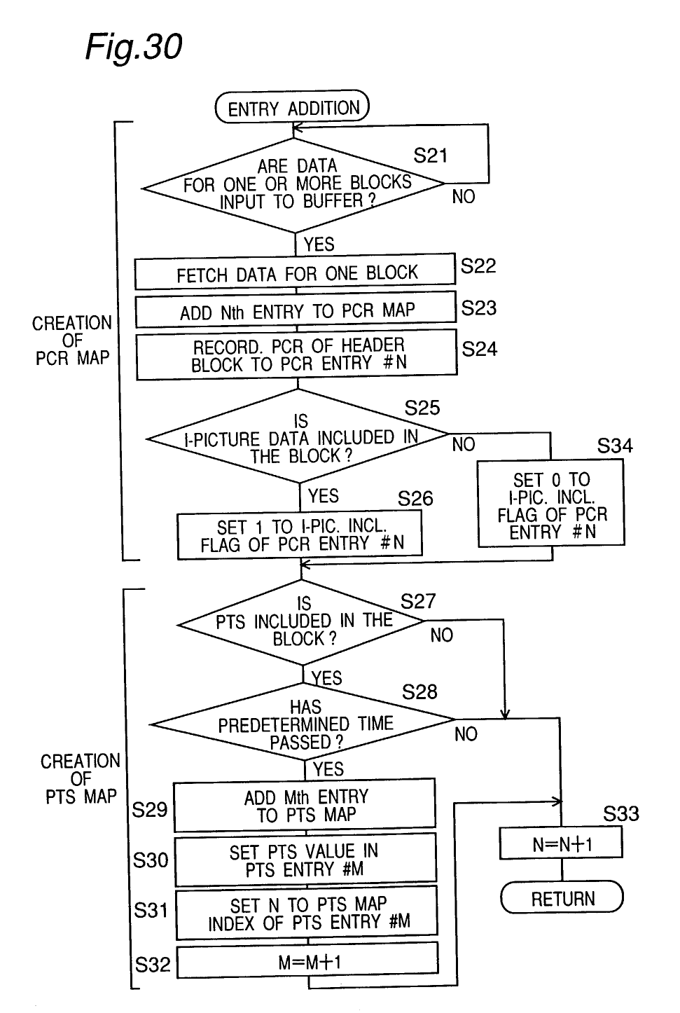

The details of the process of creating the time map by the analyzing section 1906 will be described below with reference to the flow charts of FIGS. 29 and 30.

As shown in FIG. 29, first, a counter M indicative of the additional entry number of the PCR map 811 and a counter N indicative of the additional entry number of the PTS map 813 are set to 1, respectively (S11). Next, it is decided (S12) whether or not the data on all objects which are designated by the cell information in the PGC information are subjected to an entry adding process (S13) which will be described below. The data on all the objects are subjected to the entry adding process (S13).

FIG. 30 is the flow chart showing the entry adding process (S13).

In this process, when data for one block or more are input to a track buffer (S21), the data for one block are fetched (S22) and the Nth entry (entry #N) designated by the counter N is added to the PCR map (S23). The PCR value of a head transport packet included in a block corresponding to the PCR entry #N is recorded on the PCR value of the same entry (S24). Then, it is decided whether the I-picture is included in the block or not (S25). When the I-picture is included, the I-picture included flag of the PCR entry #N is set to “1 (ON)” (S26). Otherwise, the flag is set to “0 (OFF)” (S34).

Thereafter, it is decided whether the PTS is included in the block or not (S27). When the PTS is not included, the routine proceeds to Step S33. When the PTS is included in the block, it is decided whether or not a predetermined time or more has passed after the entry of the PTS was previously added (S28). That is, the entry is not added to the PTS map 813 for all the blocks including the PTS, but is added to the map 813 for the block including the PTS such that one PTS is included for each predetermined time. Consequently, the size of the PTS map 813 is limited.

When it is decided that the predetermined time or more has not passed after the entry of the PTS was previously added at Step S28, the routine proceeds to Step S33. When the predetermined time or more has passed after the entry of the PTS was previously added, an entry is newly added to the PTS map 813 (S29). More specifically, the Mth entry (entry #M) indicated by the counter M is added to the PTS map 813. Then, a PTS value is set to the PTS value of the PTS entry #M (S30), N is set to an index for the PCR map of the PTS entry #M (S31), and the N is incremented (S32). Finally, M is incremented at Step S33. Thus, the present process is ended.

(Player)

The structure and basic operation of a player is also almost the same as the structure and basic operation described in the first embodiment.

In the present embodiment, particularly, a reproducing start block and a reproducing end block are calculated for the reproducing start position information and the reproducing end position information in the cell information by referring to the PCR map and the I-picture included flag as described in the present embodiment.

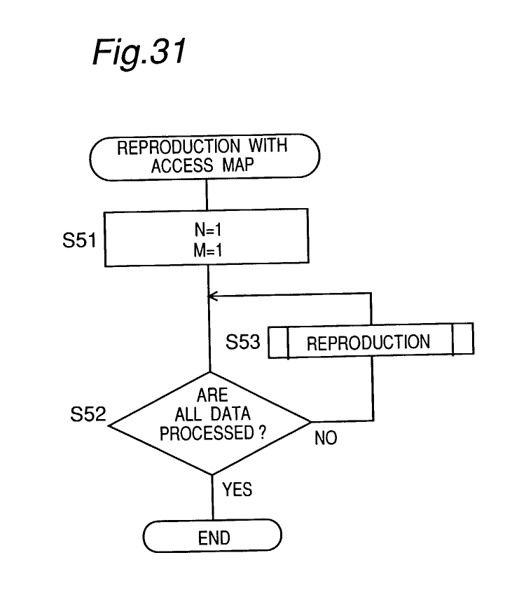

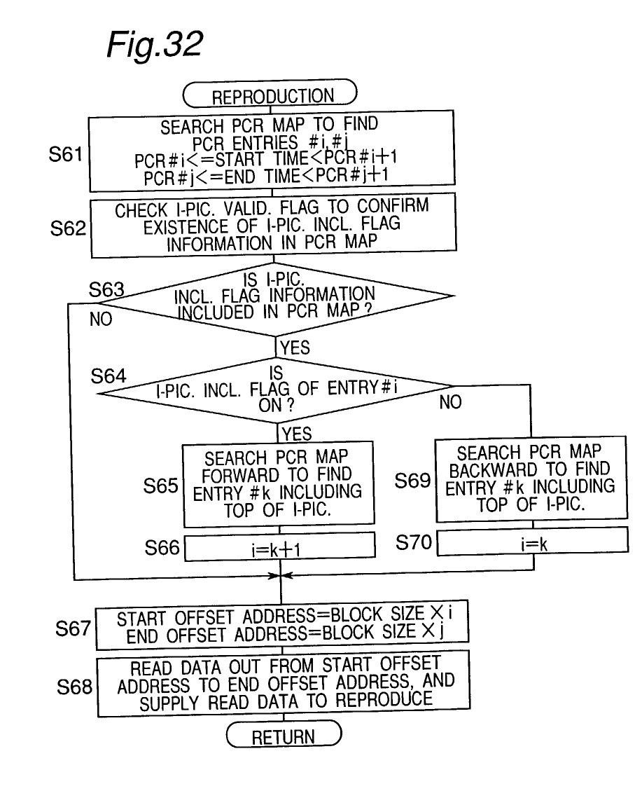

The details of the reproducing process referring to a time map will be described below with reference to the flow charts of FIGS. 31 and 32. The present process is implemented by a system controller 2002.

As shown in FIG. 31, first, the counters M and N are set to 1 (S51). Next, it is decided whether or not the following reproducing process (S53) has been carried out for data on all objects which are designated by the cell information in the PGC information (S52), and the reproducing process (S53) is carried out for the data on all the objects.

FIG. 32 is the flow chart showing the reproducing process (S53). The present reproducing process serves to reproduce the designated object from a designated start time to a designated end time.

First of all, a start time (Start) and an end time (End) which are designated in the cell information are mapped onto the entry of the PCR map 811. Concretely, the PCR map 811 is searched to calculate PCR entries #i and #j which satisfy the following equations based on the designated start time and end time (S61).

PCR #i≦Start<PCR #i+1 (3)

PCR #j<End≦PCR #j+1 (4)

Next, the I-picture flag validity flag in the general information of the object is checked to ascertain whether the I-picture included flag information is present in the PCR map 811 or not (that is, the I-picture included flag information is valid or not) (S62). As a result, when it is decided that the I-picture included flag information is not present in the PCR map 811 (that is, the I-picture included flag information is invalid) (S63), the routine proceeds to Step S67.

On the other hand, when it is decided that the I-picture included flag information is present in the PCR map 811 (that is, the flag information is valid) (S63), it is decided whether the I-picture included flag of the PCR entry #i is ON or not (S64). When the I-picture included flag of the PCR entry #i is ON, the PCR map 811 is searched forward from the entry #i, thereby finding an entry #k including the head of the I-picture (S65). More specifically, a maximum k is found, which satisfies k≦i and with which the I-picture included flag of the PCR entry #k is OFF. Then, i is calculated with i=k+1 (S66), and the routine proceeds to Step S67.

When the I-picture included flag of the PCR entry #i is not ON (S64), the PCR map is searched backward from the entry #i, thereby obtaining an entry #k including the head of the I-picture (S69). More specifically, a minimum k is obtained, which satisfies k≧i and with which the Ipicture included flag of the PCR entry #k is ON. Then, i is obtained with i=k (S70), and the routine proceeds to Step S67.

At Step S67, a start offset address and an end offset address are calculated by the following equations, respectively.

Start offset address=Block size×i (5)

End offset address=Block size×i (6)

Then, data are sequentially read out from the file based on the start offset address and the end offset address, and are supplied to a decoder for reproducing (S68).

(Variations)

While the recording of the stream is carried out for each ECC block in the above embodiment, the same advantages can also be obtained for other fixed-length block units, that is, it is not restricted to the ECC block unit. Moreover, while the block unit is fixed in the stream, it may be fixed in an optical disc.

Furthermore, while the value stored in the PCR map is the PCR value of the transport stream, it may be an SCR (System Clock Reference) in a program stream, or it may be a time for input to a system decoder.

Although in the above embodiment, provided is the I-picture included flag for deciding whether the I-picture is included in the block or not, it is also possible to provide a flag (reference picture included flag) comprising a plurality of bits and indicating whether the I-picture and P-picture are included or not.

While the PCR entry #i for each of reproducing and deleting start is calculated by using the equation (1) based on the start position information of the cell information (CellI) when reproducing and deleting data, i may be calculated with approximation by the following equation.

PCR #i≦Start<PCR #i+1 (7)

Moreover, In the above embodiment, the I-picture included flag is checked to detect the reproducing start block during the reproducing operation. When the I-picture is not present in the block, the PCR entry is checked in the backward direction. On the contrary, the PCR entry may be checked in the forward direction, that is, detection may be performed by returning to the head block of the forward I-picture.

Furthermore, the I-picture included flag is checked to detect the reproducing start block during the reproducing operation. If the I-picture is present in the block, the PCR entry is checked in the forward direction to return to the head of the I-picture. On the contrary, the PCR entry may be checked in the backward direction, thereby performing the retrieval to proceed to the head of the next I-picture.

Moreover, in the deleting operation, the I-picture included flag is checked to detect the deleting start block. When the I-picture is not included in the block, the PCR entry is checked in the forward direction, thereby detecting the deleting start block. On the contrary, the PCR entry may be checked in the backward direction to detect the deleting start block.

Furthermore, in the deleting operation, the I-picture included flag is checked to detect the deleting start block. When the I-picture is included in the block, the PCR entry is checked in the backward direction, thereby detecting the deleting start block. On the contrary, the PCR entry may be checked in the forward direction to detect the deleting start block.

While the block number “j” of the reproducing end block or the deleting end block is calculated by using the equation (2) based on the end position information of the cell information during the reproducing operation and the deleting operation, it may be calculated in a reverse direction by the following equation.

PCR #j≦End<PCR #j+1 (8)

Moreover, during the reproducing operation, in the case where the reproducing end block determined by the reproducing end position designated by the user includes the I-picture, the head block including the same I-picture may be retrieved in the forward or backward direction and the retrieved block may be set to the reproducing end block in the same manner as in the case of the reproducing start block.

In the reproducing operation, furthermore, the reproducing start block or the reproducing end block designated by the user may simply be mapped onto the PCR entry, thereby determining the position of the mapped block as the reproducing start and end positions without taking the position of the I-picture into consideration (that is, without detecting the block including the head of the I-picture).

During the deleting operation, detecting the head of the I-picture determines the deleting start block and the deleting end block. However, without this process, simply mapping the deleting start block and the deleting end block designated by the user onto the adjacent block may determine the start and end positions of a block group to be actually deleted.

When the N multistreams are to be stored, although the PTS map and the PCR map is extended to have N fields, M (M≧N) fields may previously be prepared to use N fields during the recording operation. At this time, N is recorded for the number of streams (Number_of_Streams) in the general information (D_VOB_GI) of the digital broadcasting object.

Although the I-picture included flag is provided for each PCR entry in the present invention, it is also possible to set, in place of the I-picture included flag, a flag indicating that each PCR entry is the head of the I-picture or not, a flag indicating that the PCR entry is the end of the I-picture or information indicative of the size of the I-picture, thereby specifying the reproducing or deleting start block by using these flags and information in the same manner as described above.

While the present invention has described the optical disc, the optical disc recorder and the optical disc player, for example, the same advantages can be obtained even if the MPEG transport stream is to be recorded on other media such as a hard disc and the like, and the present invention is not essentially restricted to physical media.

<Third Embodiment>

The third embodiment of the present invention will be described below by using a DVD recorder and a DVD-RAM as examples.

The basic structures and operations of the DVD recorder and the DVD-RAM according to the present embodiment are the same as those in the first embodiment, and therefore their description is omitted. In the following, particularly, description will be given to a data structure of a digital broadcasting object (D_VOB) which is an object for a digital broadcast and a data structure of a time map for the digital broadcasting object (D_VOB).

(Data Structure of D_VOB)

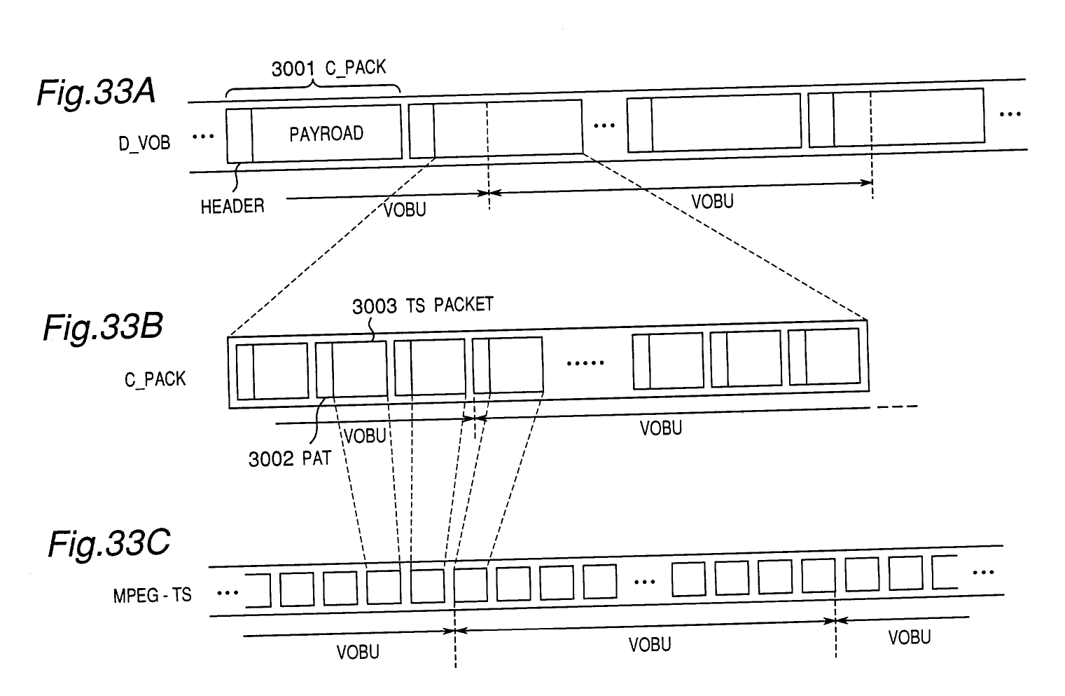

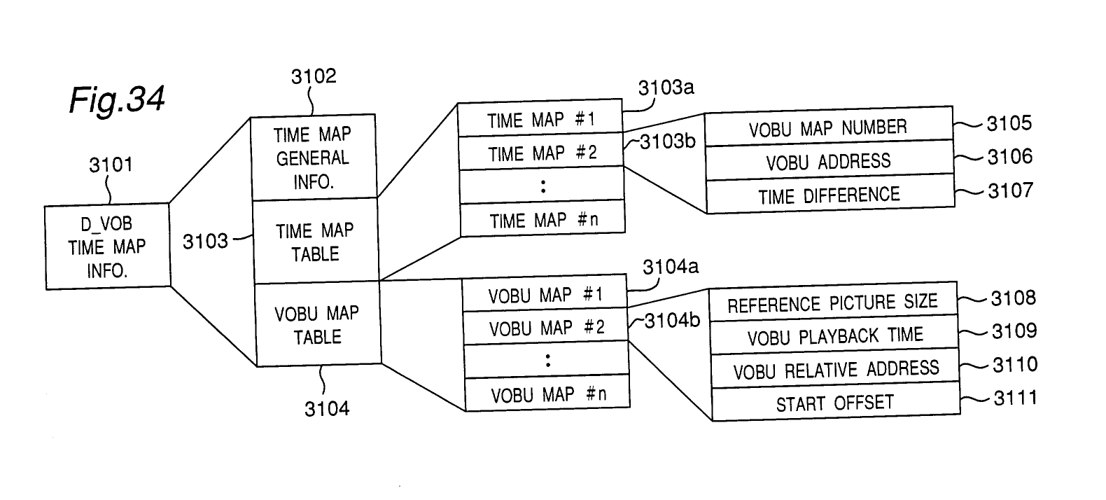

FIGS. 33A to 33C show a data structure of digital broadcasting object (D_VOB) according to the present invention. As shown in FIG. 33A, D_VOB includes capsule packs (C_PACK) 3001. C_PACK is a block having a fixed size of 1/n of ECC block in which n is an integer, and has a header part and a payload part. The payload part contains TS packets 3003 to each of which PAT 3002 indicating packet arrival time stamp is added, as shown in FIG. 33B. A size of C_PACK is fixed and therefore the number of TS packets included in the C_PACK is also constant. (Structure of D_VOB Time Map Information) FIG. 34 shows a data structure of D_VOB time map information. In this figure, D_VOB time map 3101 includes time map general information 3102 containing a general information associating with the time map, time map table 3103, and VOBU map table 3104.

The time map general information 3102 includes the number of time maps included in the time map information, the number of VOBU maps included in the time map information, time unit (TMU) indicating a constant time interval at which the time map is provided, and time offset (TM_OFS) indicating time difference between the time of a head of D_VOB and the time of the headmost time map. In the D_VOB time map information, the time unit (TMU) and the time offset (TM_OFS) are defined on PTS basis. That is, in D_VOB time map information, a time defined by PTS is related with an address.

The time map table 3103 includes a plurality of time maps 3103a, 3103b, . . . . Each time map 3103a, 3103b, . . . is provided at a constant time interval indicated by TMU, and aligned in order of time. Each time map 3103a, 3103b, . . . designates sequentially a time obtained by adding TM_OFS to the time of a head of D_VOB. Each time map 3103a, 3103b, . . . also designates, using VOBU map number, VOBU map which exists at each playback time after 1TMU, 2TMU, 3TMU, . . . Since TM_OFS is ordinary 0, the time map 3103a corresponds to a time of the head of D_VOB. When an edit is done such that, for example, a head of D_VOB is deleted, a value of TM_OFS is other than 0. Each time map 3103a, 3103b, . . . includes VOBU address 3106 that is an address of C_PACK containing a head of VOBU associating with the corresponding VOBU map, and that the address is expressed in terms of the number of C_PACKs. The time difference 3107 is a time difference between a time of a head of VOBU and a playback time designated by the time map, and is expressed in terms of the number of video fields or video frames.

The VOBU map table 3104 includes VOBU maps 3104a, 3104b, each corresponding to VOBU included in D_VOB. Each VOBU map 3104a, 3104b, includes reference picture size 3108, VOBU playback time 3109, VOBU relative address 3110, and start offset 3111. Reference picture size 3108 is a size of I-picture located at the head of VOBU, which is expressed in terms of the number of C_PACKs. VOBU playback time 3109 is a time required for playback of the associating VOBU, which is expressed in terms of the number of video fields or video frames. VOBU relative address 3110 is a relative address from the VOBU address 3106 designated at every TMU to an address of C_PACK including the head of the associating VOBU, which is expressed in terms of the number of C_PACKs. Start offset 3111 is an offset information indicating what number packet from the head of the C_PACK contains TS packet that includes the head of VOBU, in which the offset information is expressed in terms of the number of TS packets.

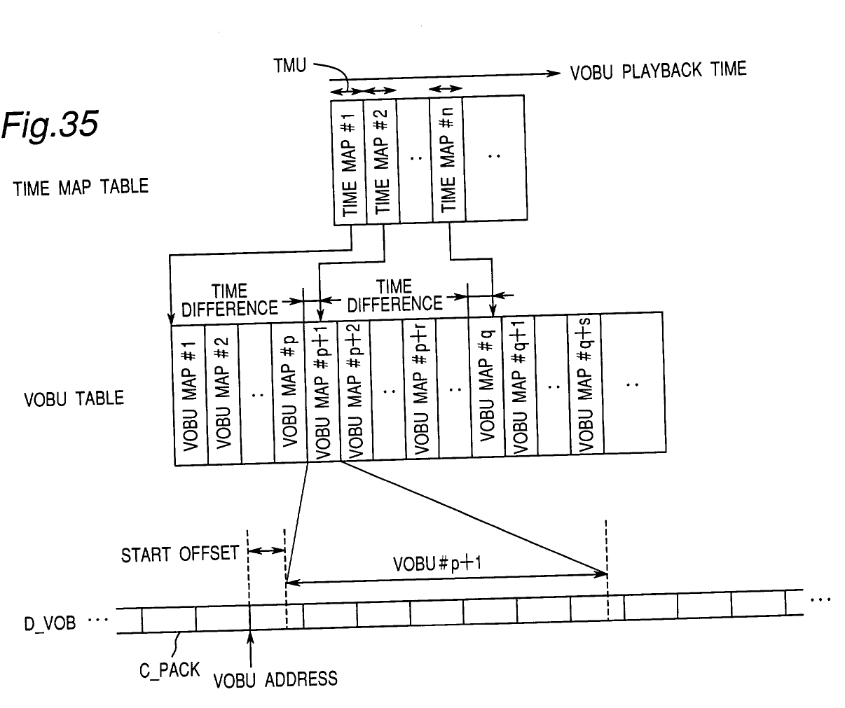

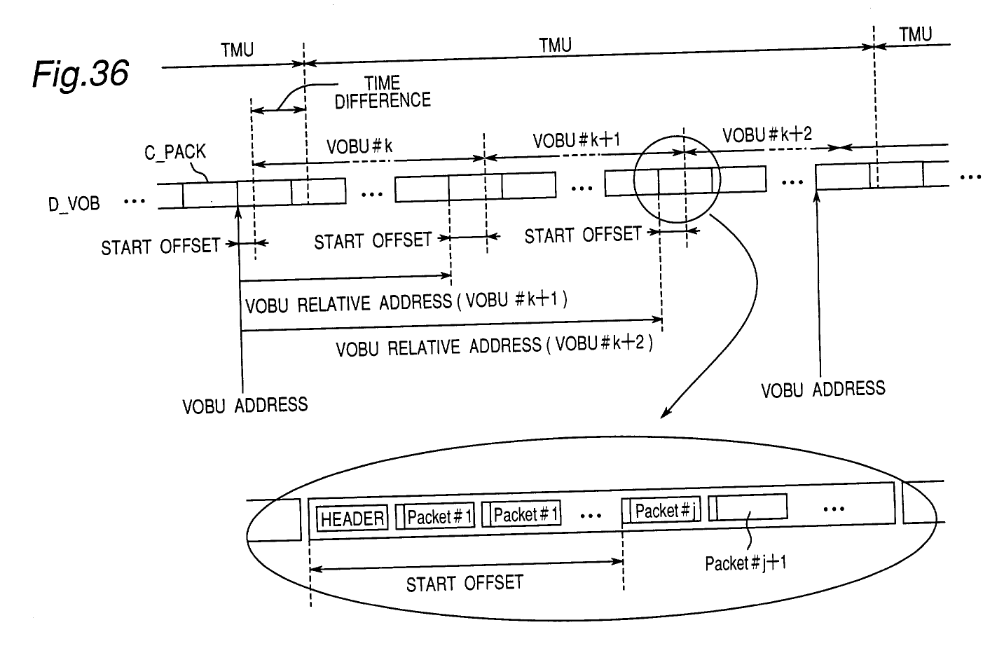

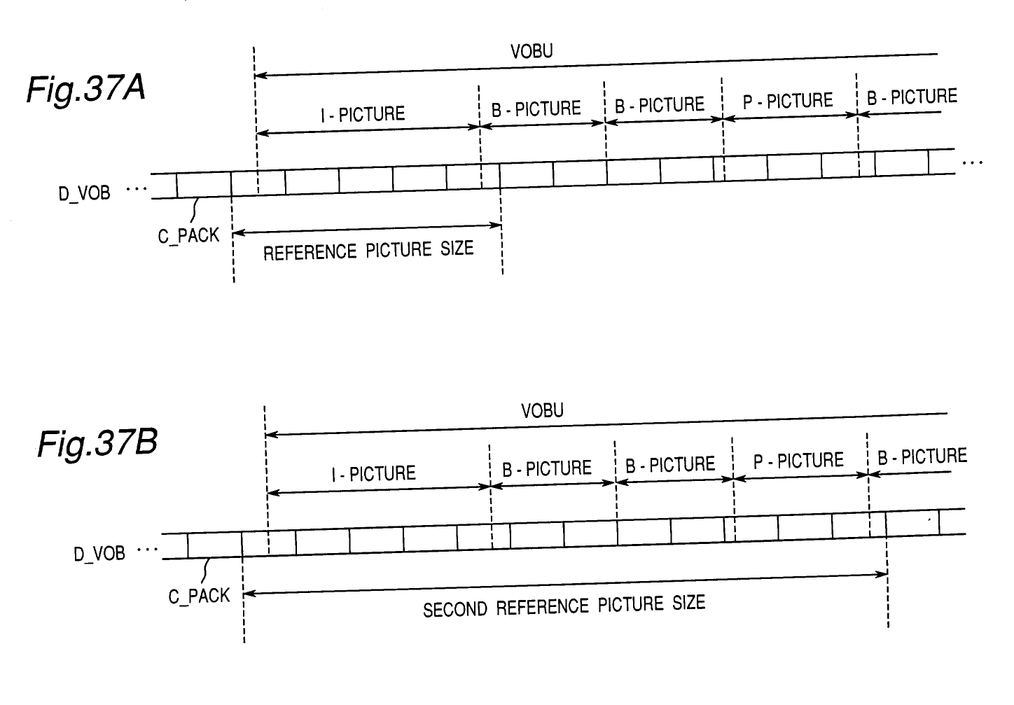

FIGS. 35 and 36 shows a relation of a time map table, VOBU table and D_VOB in data structure of D_VOB time map information. FIGS. 37A and 37B describe a method of designating a reference picture size in VOBU map. FIG. 37A describes the method in case that only a head of I-picture is designated, and FIG. 37B describes the method in case that P-picture which is the second reference picture is included.

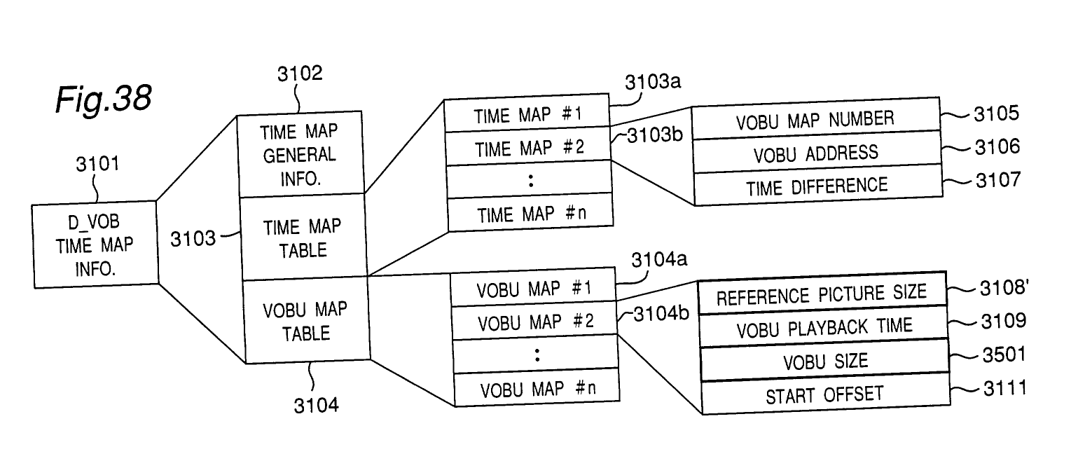

It is noted that the reference picture size included in the VOBU map may be expressed in terms of the number of TS packets included in I-picture in stead of the number of C_PACK. Similarly, VOBU relative address may be based on the number of TS packets. Even though the number of TS packets included in VOBU is used as VOBU size, features of the invention may not be reduced. That is, the number of TS packets in C_PACK is constant, and therefore it is easy to convert from the number of TS packets to the number of C_PACK +offset packet. When there is no VOBU relative address, a target VOBU address can easily be obtained by accumulating VOBU size. FIG. 38 shows a data structure of D_VOB time map information in such a case. In this figure, reference picture size 3108′ is a size of a reference picture expressed in terms of the number of TS packets. VOBU size 3501 is a size of VOBU expressed in terms of the number of TS packets.

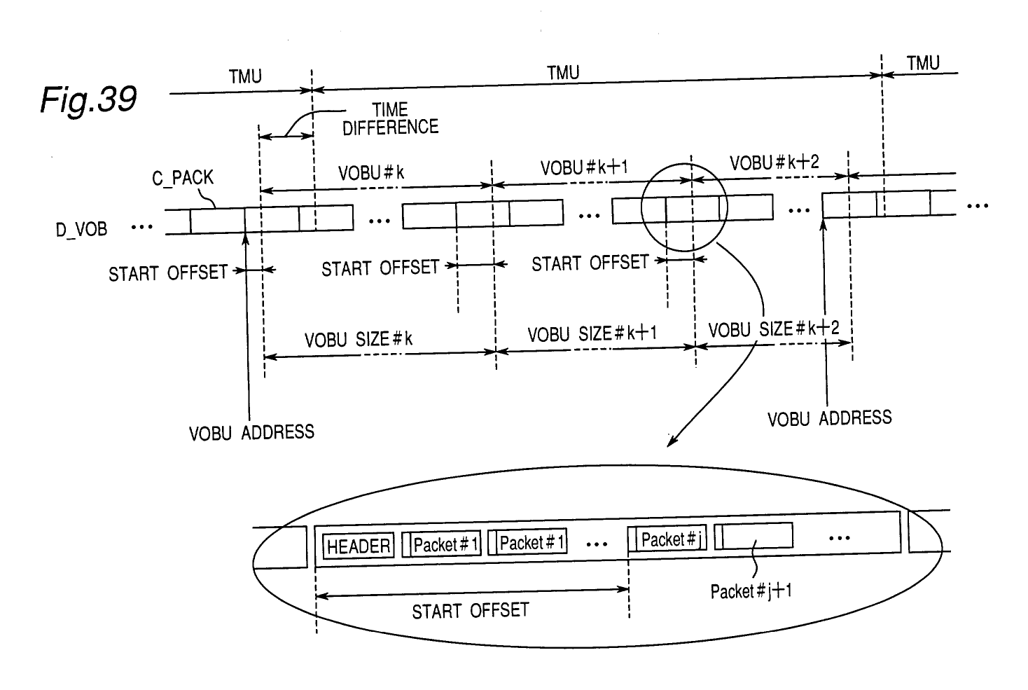

FIG. 39 shows a relation between VOBU table and D_VOB in this data structure. In this case, VOBU address 3106 of the time map entry can be expressed in terms of the number of TS packets instead of the number of C_PACKs. In this case, start offset 3111 in the VOBU map becomes needless because it can be easily obtained from the VOBU address which is expressed in terms of the number of TS packets.

By using the time map information with the data structure described above, the designated time can be easily converted to the address on the disc for data access, and the address of the I-picture can be specified. Therefore, the special reproducing such as a first forwarding play and a reverse direction play can easily be actualized.

When the designated time is converted into an address on the disc, addressing may be done such that data transfer to the decoder is commenced from data of VOBU just before the VOBU associating with the designated time in order to construct PSI/SI information. In this case, presentation can be started from VOBU associating with the designated time.

In this embodiment, VOBU of D_VOB is a minimum unit to access D_VOB. When I-picture appears at short time interval, the short access unit is generated and thus the table size may be larger. Therefore, it is effective to make limits such as minimum playback time of VOBU to be more than 0.4 sec. It is also effective to create a plurality of VOBU maps having different VOBU size or different access precision are created, and thus to select suitable VOBU map according to work memory size of the player, at playback operation.

Though in this embodiment the time map and VOBU map are stored in one management information file “VIDEO_RT.IFO”, the time map may be in the management information file and VOBU map may be in the object data. For example, VOBU map may be divided at every time interval corresponding to the time unit, and then located before each object data configured at time corresponding to each time unit, so that the divided VOBU map can be read sequentially at playback operation. This can provide the same access performance as that of the above embodiment, and further reduce the size of the management information file and the size of work memory required for the player at playback operation.

(Creation of D_VOB Time Map Information in Recorder)

The basic structures and operations of the recorder according to the present embodiment are the same as those in the first embodiment. The remarkable point is that the analyzer 1906 for analyzing digital broadcasting data has the ability to create the time map and VOBU map described above.

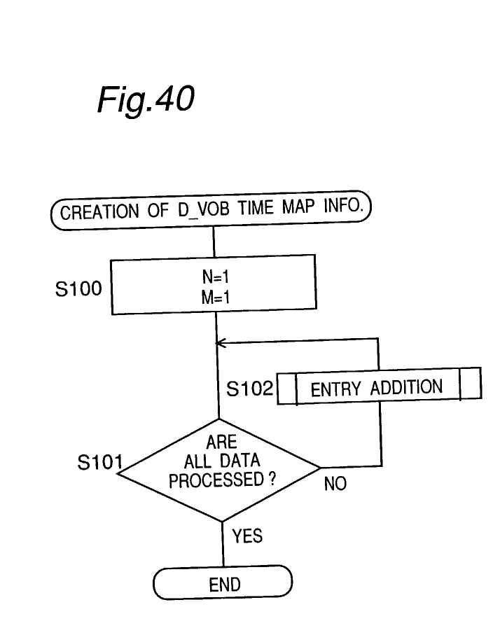

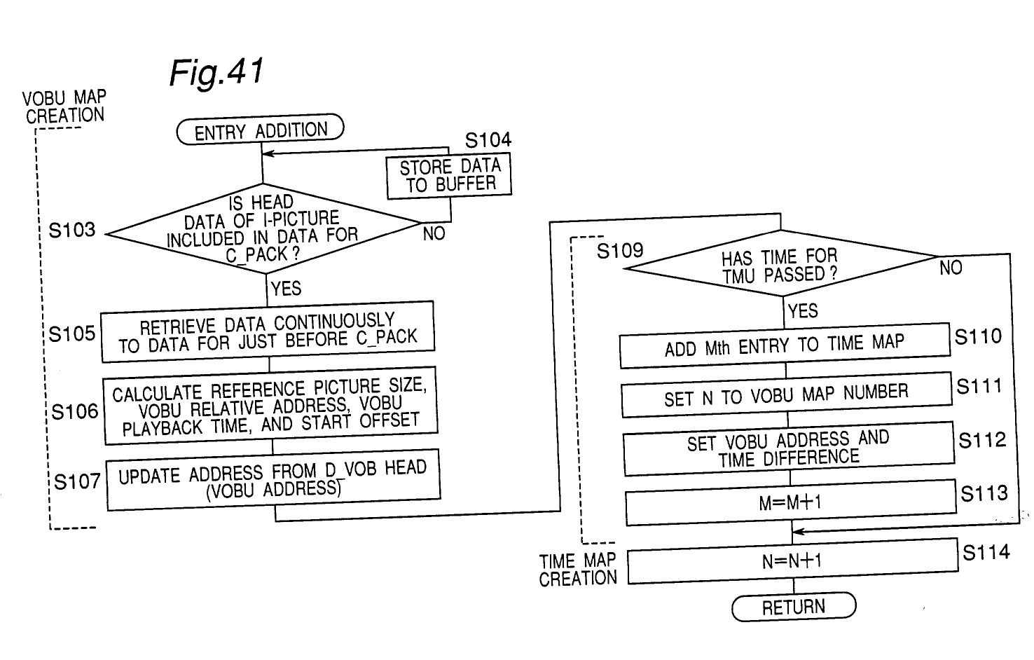

In the following, description will be made to a process of creating the time map in the analyzer 1906 with reference to flowcharts of FIGS. 40 and 41.

It is noted that here the description is made to the time map and VOBU map having structures shown in FIG. 34.

As shown in FIG. 40, a counter N which points out additional entry number of VOBU map and a counter M which points out additional entry number of time map are set to 1, respectively (S100). Next, while it is determined whether entry addition process is performed to all of object data designated by the cell information in the PGC information (S101), the entry addition process is performed to all of object data (S102).

The entry addition process is shown in a flowchart of FIG. 41. In this process, data is stored to the data buffer (S104) until the capsule pack containing the head data (it may be GOP header or sequence header) of I-picture which is also the head data of VOBU is detected (S103). When the head data of I-picture data is detected, the process is done that records the entry regarding the just before VOBU onto VOBU map. Concretely, data of continuous C_PACKs before the C_PACK in which I-picture is detected is read out from the data buffer (S105). The read data contains data including and following the data associating with C_PACK including the head data of I-picture which is detected at the previous operation before the current operation in which the head data of I-picture is detected. This data is analyzed to calculate reference picture size, VOBU relative address, VOBU playback time, and start offset (S106). Address information is updated that is used to calculate VOBU address which is a relative address from the head of D_VOB and which is used as address information on the time map side (S107). The Nth entry is created in VOBU map, and currently calculated information is set (S108). This is a process of creating VOBU.

Subsequently, the time map is created. First, it is determined whether the time passes for a time equal to the time unit (TMU) from when the entry of the previous time map is last created (S109). If the time has not passed yet, the steps for creating entry of the time map are skipped. If the has passed for a time equal to TMU, a new entry which indicated by the additional entry counter M is added to the time map (S110). VOBU map number is set with the count of the counter N (S111). Further, VOBU address and time difference are calculated and set (S112). The counter M increments (S113). Finally, the counter N increments (S114), and then the process ends.

(Playback Operation in Player)

The basic structures and operations of the player according to the present embodiment are the same as those in the first embodiment. The remarkable point is that address information on the disc is calculated from playback start time and playback end time in the cell information using the time map and VOBU map.

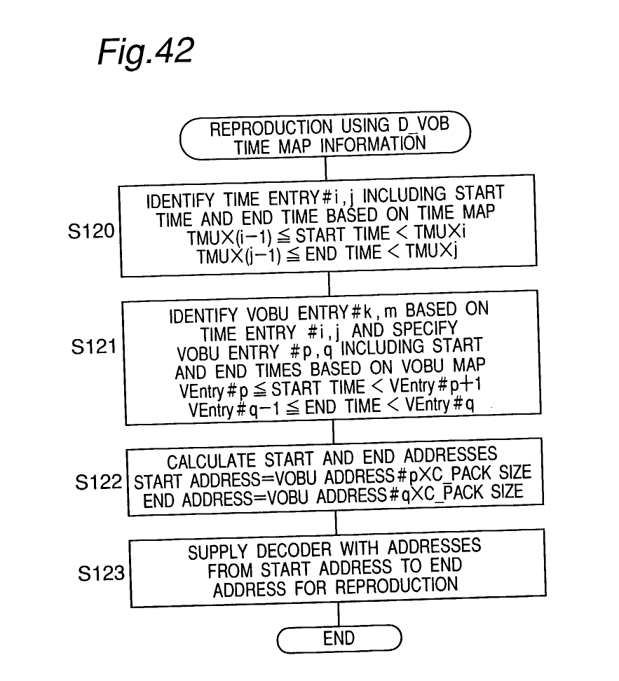

In the following, description will be made to a playback process of the analyzer 1906 using the time map, with reference to a flowchart of FIG. 42.

As shown in FIG. 42, in this process the designated digital broad casting object (D_VOB) is reproduced from the designated start time to the designated end time.

Fist, it is determined which number entry includes the designated start time and the end time, by comparing the time unit (TMU) (S120). Here, as the determination result, it is specified that the start time is included in TMU which starts from the time entry #i and the end time is included in TMU which starts from the time entry #j. Using the time entries #i and #j, the corresponding VOBU entries #k and #m can be identified. Then, referring to VOBU map, VOBUs including the start time and the end time are identified (S121). In this case, regarding the playback start point, a start address of VOBU including the playback start time is identified. However, regarding the playback end point, an end address of VOBU including the playback end time, that is, a start address of the next VOBU should be identified to supply data completely.

Subsequently, the start address and the end address are calculated from the identified VOBU entries (S122). When the time map and VOBU map have data structures shown in FIG. 34, the start address based on C_PACK count is obtained by adding a relative address of VOBU corresponding to VOBU entry #p to an address of VOBU corresponding to time entry #i. Similarly, the end address based on C_PACK count is obtained by adding a relative address of VOBU corresponding to VOBU entry #q to an address of VOBU corresponding to time entry #j.

When the time map and VOBU map have data structures shown in FIG. 38, the start address based on C_PACK count is obtained by adding sequentially each size of VOBUs corresponding to VOBU entries #k to #p to an address of VOBU corresponding to time entry #i. Similarly, the end address based on C_PACK count is obtained by adding sequentially each size of VOBUs corresponding to VOBU entries #m to #q to an address of VOBU corresponding to time entry #j. Multiplied by the data size of C_PACK, the address based on C_PACK count thus obtained can easily be converted to the disc address. Data is read from the start address to the end address obtained as above on the disc, and supplied to the decoder sequentially to perform the playback.

(Muliti-Stream)

In case of multistream in which a plurality of programs are multiplexed into one MPEG-TS, a plurality of D_VOB time maps are provided similar to the second embodiment and the number of streams included is recorded to the time map general information.

In case of multiviewstream in which a plurality of streams those associating each other are multiplexed, only the time map information relating to the representative stream is recorded, and the time map general information is recorded with information indicating that there are a plurality of stream but only the time map information relating to the representative stream is recorded. In this case, the cell information may be recorded with information indicative of multiviewstream and the number of streams, and thus it can be determined that the time map information is the map information for the representative stream because there is only one time map.

<Fourth Embodiment>

The forth embodiment of the invention is substantially equivalent to the third embodiment except the D_VOB structure and the time map structure. The D_VOB structure and the time map structure will be described below.

(D_VOB Structure)

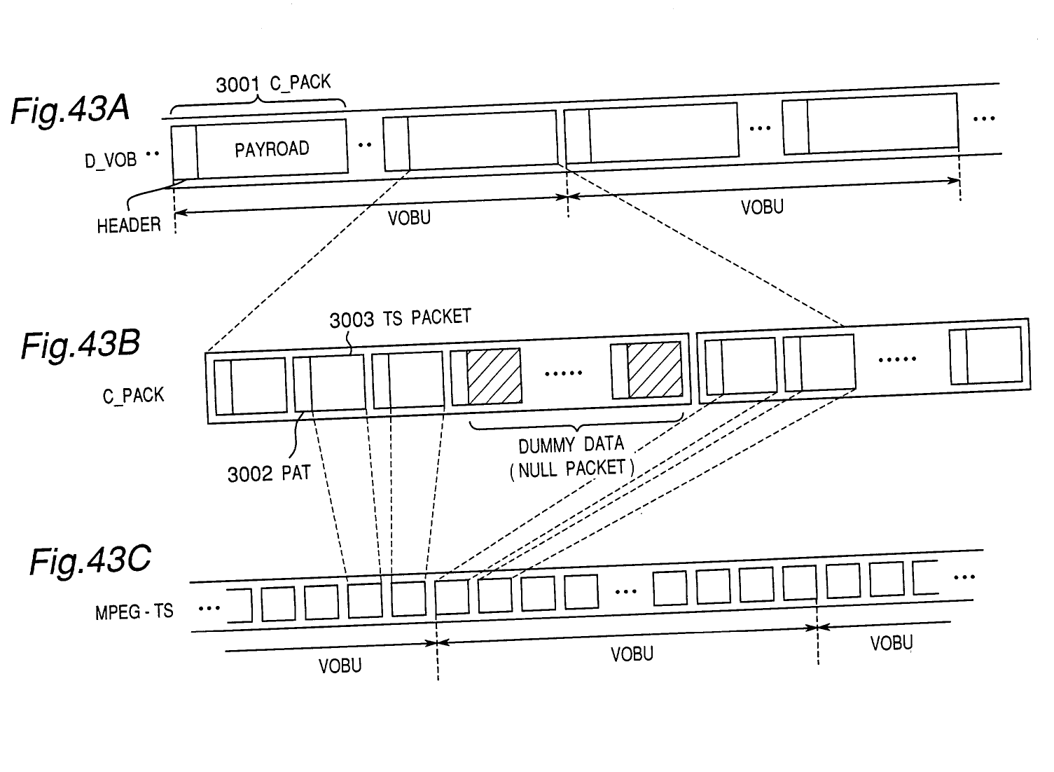

FIGS. 43A to 43C shows a data structure of digital broadcasting object (D_VOB) according to the present invention. As shown in FIG. 43A, D_VOB includes capsule packs (C_PACK) 3001. C_PACK is a block with a block size of 1/n of ECC block in which n is an integer, and has a header part and a payload part. The payload part contains TS packets 3003 to each of which PAT 3002 indicating packet arrival time is added, as shown in FIG. 43B. A size of C_PACK is fixed and therefore the number of TS packets included in the C_PACK is also constant. When C_PACK is constructed from MPEG-TS, alignment is done on a border of VOBUs. That is, if the tail end of VOBU is not accordant with the tail end of C_PACK, the alignment is done by padding with dummy data that may be null packets.

(D_VOB Time Map Information Structure)

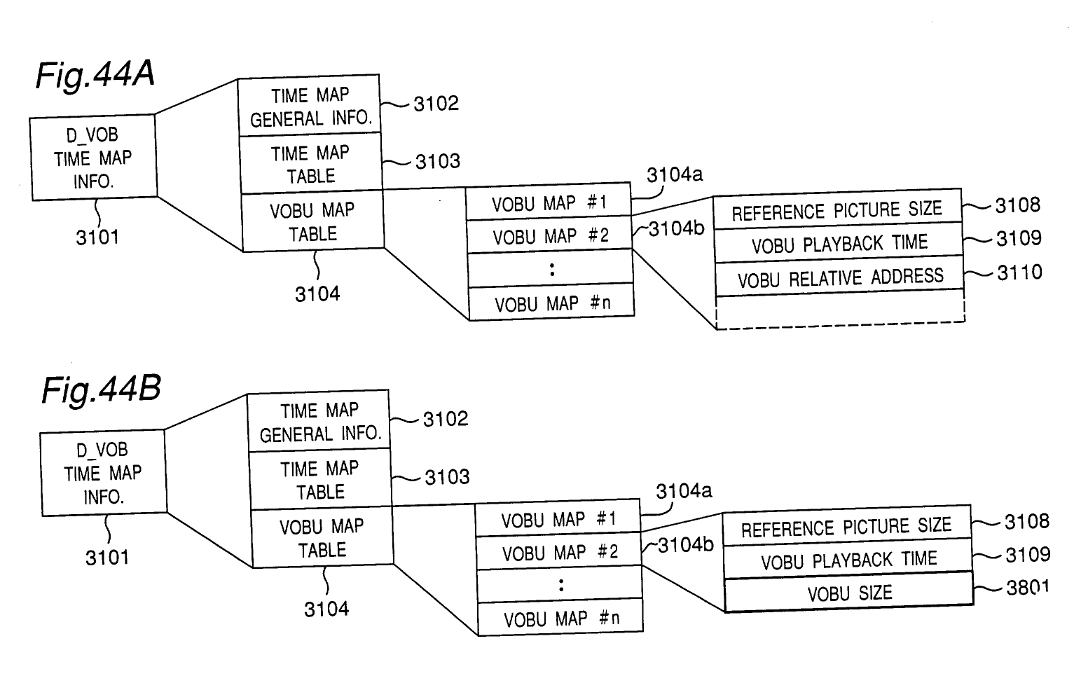

FIGS. 44A and 44B shows a data structure of D_VOB time map information. As shown in FIG. 44A, the present invention does not have the start offset 3111 of VOBU map table in the data structure shown in FIG. 34, because D_VOB is constructed by aligning a head of C_PACK and a head of VOBU.

FIG. 44B shows a data structure of VOBU map including VOBU size 3801 instead of a VOBU relative address 3110. VOBU size 3801 represents a size of VOBU using the number of C_PACKs. This can reduce data amount more than when the size is expressed by VOBU relative address 3110. To obtain an address of a target VOBU, VOBU sizes are accumulated.

As described above, the time map information of this embodiment can reduce the time map, together with a random access to the disc.

When the designated time is converted into an address on the disc, addressing may be done such that data transfer to the decoder is commenced from data of VOBU just before the VOBU associating with the designated time in order to construct PSI/SI information. In this case, presentation can be started from VOBU associating with the designated time.

VOBU of D_VOB in this embodiment is a minimum unit to access D_VOB. When I-picture appears at short time interval, the short access unit is generated and thus the table size may be larger. Therefore, it is effective to make limits such as minimum playback time of VOBU to be more than 0.4 sec. It is also effective to create a plurality of VOBU maps having different VOBU size or different access precision are created, and thus to select suitable VOBU map according to work memory size of the player, at playback operation.

Though in this embodiment the time map and VOBU map are stored in one management information file “VIDEO_RT.IFO”, the time map may be in the management information file and VOBU map may be in the object data. For example, VOBU map may be divided at every time interval corresponding to the time unit, and then located before each object data configured at time corresponding to each time unit, so that the divided VOBU map can be read sequentially at playback operation. This can provide the same access performance as that of the above embodiment, and further reduce the size of the management information file and the size of work memory required for the player at playback operation.

<Fifth Embodiment>

The fifth embodiment of the present invention will be described below by using a DVD recorder and a DVD-RAM as examples.

The basic structures and operations of the DVD recorder and the DVD-RAM according to the present embodiment are the same as those in the first embodiment, and therefore their description is omitted. In the following, particularly, description will be given to a data structure of object data to record the stream object (SOB) which is a digital broadcasting object of which content is not identified, and a data structure of the time map for this digital broadcasting object (SOB).

(Data Structure of SOB)

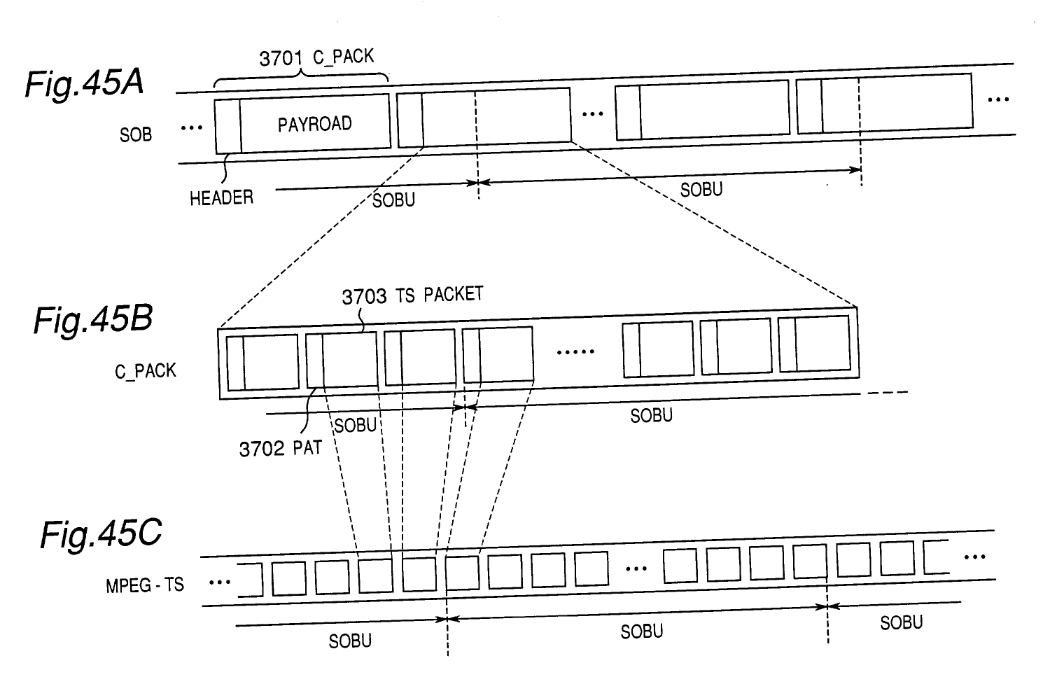

FIGS. 45A to 45C show a data structure of stream object (SOB) according to the present invention. As shown in FIG. 45A, 5OB includes capsule packs (C_PACK) 3701. C_PACK is a block having a fixed size of 1/n of ECC block in which n is an integer, and has a header part and a payload part. The payload part contains TS packets 3003 to each of which PAT 3702 indicating packet arrival time is added, as shown in FIG. 45B. A size of C_PACK is fixed and therefore the number of TS packets included in the C_PACK is also constant. It is noted that SOB is composed of SOBUs each of which is a block provided at a constant time interval.

(Structure of SOB Time Map Information)

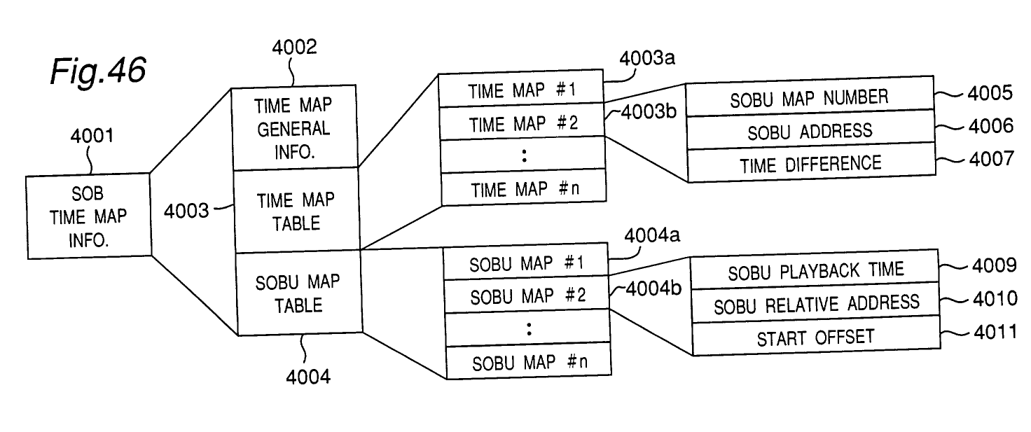

FIG. 46 shows a data structure of SOB time map information. In this figure, SOB time map 4001 includes time map general information 4002 containing a general information associating with the time map, time map table 4003, and VOBU map table 4004.

The time map general information 4002 includes the number of time maps included in the time map information 4001, the number of VOBU maps included in the time map information 4001, time unit (TMU) indicating a constant time interval at which the time map is provided, and time offset (TM_OFS) indicating time difference between the time of a head of SOB and the time of the headmost time map. In the S_VOB time map information, the time unit (TMU) and the time offset (TM_OFS) are defined on ATS basis. That is, in SOB time map information, a time defined by ATS is related with an address.

The time map table 4003 includes a plurality of time maps 4003a, 4003b. Each time map 4003a, 4003b. is provided at a constant time interval indicated by TMU, and aligned in order of time. Each time map 4003a, 4003b, designates sequentially a time obtained by adding TM_OFS to the time of a head of SOB. Each time map 4003a, 4003b, also designates, using SOBU map number, SOBU map which exists at each playback time after LTMU, 2TMU, 3TMU. Since TM_OFS is ordinary 0, the time map 4003a corresponds to a time of the head of SOB. When an edit is done such that, for example, a head of SOB is deleted, a value of TM_OFS is other than 0. Each time map 4003a, 4003b, includes SOBU address 4006 that is an address of C_PACK containing a head of VOBU associating with the corresponding VOBU map, and that the address is expressed in terms of the number of C_PACKs. The time difference 4007 is a time difference between a time of a head of SOBU and a playback time designated by the time map, and is expressed by a difference between the corresponding PATs.

The SOBU map table 4004 includes SOBU maps 4004a, 4004b, each corresponding to SOBU included in SOB. Each SOBU map 4004a, 4004b, includes SOBU playback time 4009, SOBU relative address 4010, and start offset 4011. SOBU playback time 4009 is a time required for playback of the associating SOBU, which is expressed by the difference of PATs. SOBU relative address 4010 is a relative address from the VOBU address 4006 designated at every TMU to an address of C_PACK including the head of the associating SOBU, which is expressed in terms of the number of C_PACKs. Start offset 4011 is an offset information indicating what number packet from the head of the C_PACK contains TS packet that includes the head of VOBU, in which the offset information is expressed in terms of the number of TS packets.

The relation among the time map table, SOBU table and SOB in the data structure of the SOB time map information as described above is substantially the same as the relation for D_VOB described in the third embodiment as shown in FIG. 36. That is, SOBU is defied instead of VOBU, ATS is used as a time axis instead of ATS, but the reference picture does not exit.

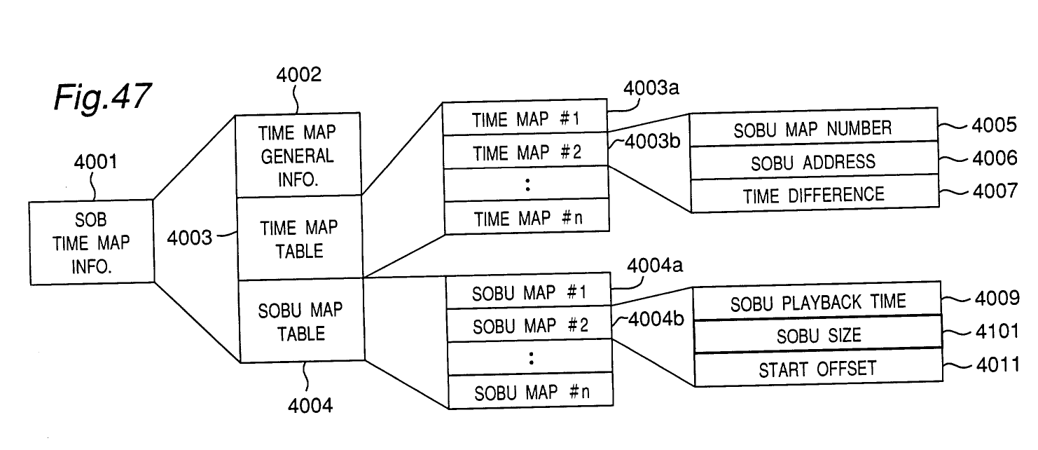

FIG. 47 shows a data structure of SOB time map information which has substantially the same data structure as that shown in FIG. 43 but records SOBU size 4101 instead of SOBU relative address 4010. SOBU size 4101 is a size of SOBU that is expressed in terms of the number of TS packets. In this case, an address of the target SOBU can be easily obtained by accumulating SOBU size 4101 sequentially. It does not reduce accessibility. SOBU address 4006 may be expressed in terms of the number of TS packets. Then, the number of C_PACKs+the number of start offset packets can be easily be obtained from the number of TS packets, resulting in needlessness of start offset 4011.

Using the time map with the above described data structure, it becomes possible to convert the designated time on the basis of TS packet arrival time into the disc address and thus to access MPEG-TS stream of which contents are not identified.

The process of creating the time map to SOB and the process of playback using the time map to SOB are the same as the processes to D_VOB shown in the flowcharts of FIGS. 41 and 42. The difference point is that, in the time map creation process, while regarding D_VOB VOBU is created for each head of I-picture (see steps S103-S104 in FIG. 41), regarding SOB SOBU is created for each data which is input at a predetermined interval. This is because SOBU can not be analyzed with its contents and I-picture can not be identified. The other processes are substantially the same, and therefore the flowcharts of FIGS. 40 to 42 can be referred to by reading SOB as D_VOB and SOBU as D_VOBU in the flowcharts.

It is noted that functions, described in the above embodiments, of hardware such as DVD recorder and DVD player can be performed by, for example, a computer executing predetermined control programs which may be supplied to the computer via a recording medium.

Although the present invention has been described in connection with specified embodiments thereof, many other modifications, corrections and applications are apparent to those skilled in the art. Therefore, the present invention is not limited by the disclosure provided herein but limited only to the scope of the appended claims.

What is claimed is:

1. A information recording medium storing digital data and management information managing the digital data, wherein
the management information comprises:
first time map information provided for a first object that is a digital stream in which digital data is packet-multiplexed, and in which, for each predetermined unit, an address on the medium of the digital data is related to a playback time of the digital data and stored to the medium; and
second time map information provided for a second object that is a digital stream in which digital data is packet-multiplexed for each predetermined unit, of which contents can not be identified, and in which, for each predetermined unit, an address on the medium of the digital data is related to an arrival time of the packet and stored to the medium.

2. The information recording medium according to claim 1, wherein the first object and the second object are recorded separately to different object files.

3. A recording apparatus for recording a digital stream in which digital data is packet-multiplexed to a recording medium, wherein:
the recording medium capable of storing first time map information in which, for each predetermined unit, an address on the medium of the digital data is related to a playback time of the digital data and stored, and second time map information in which, for each predetermined unit, an address on the medium of the digital data is related to an arrival time of the packet and stored;
the apparatus comprises
I/F section that receives the digital stream from external,
map creation section that creates the time map information according to the received digital stream, and
recording section that records the digital stream and the time map information to the recording medium; and
in recording the digital stream to the recording medium, the map creation section analyzes the digital stream, and based on the analysis result creates the first time map information when the playback time information can be identified, or creates the second time map information when the playback time information can not be identified.

4. A recording method of recording a digital stream in which digital data is packet-multiplexed to a recording medium, wherein:
the recording medium is capable of storing
first time map information in which, for each predetermined unit, an address on the medium of the digital data is related to a playback time of the digital data and stored, and second time map information in which, for each predetermined unit, an address on the medium of the digital data is related to an arrival time of the packet and stored; and
the method comprises
analyzing the digital stream for recording the digital stream to the recording medium,
creating the first time map information when the playback time information can be identified, or creating the second time map information when the playback time information can not be identified, based on the analysis result, and
recording the digital stream and the time map information to the recording medium.

5. A reproducing apparatus for reproducing information from a recording medium storing a digital stream in which digital data is packet-multiplexed, wherein:
the recording medium is capable of storing first time map information in which, for each predetermined unit, an address on the medium of the digital data is related to a playback time of the digital data and stored, and second time map information in which, for each predetermined unit, an address on the medium of the digital data is related to an arrival time of the packet and stored;
the apparatus comprises
reproducing section that reads and reproduces the digital stream from the recording medium,
I/F section that receives information to designate the digital stream to be reproduced and information to designate start time of the playback, and
control section to control the reproducing section; and
the control section controls the reproducing section so as to determine whether the time map information of the designated digital stream is the first time map information or the second time map information, specify a read address with reference to the time map information by using a time axis according to the type of the time map information, and then start the playback from the specified address.

6. A reproducing method of reproducing information from a recording medium storing a digital stream in which digital data is packet-multiplexed, wherein:
the recording medium is capable of storing first time map information in which, for each predetermined unit, an address on the medium of the digital data is related to a playback time of the digital data and stored, and second time map information in which, for each predetermined unit, an address on the medium of the digital data is related to an arrival time of the packet and stored;
the method comprises
reading and reproducing the digital stream from the recording medium,
receiving information to designate the digital stream to be reproduced and information to designate start time of the playback, and
controlling the playback; and
the controlling comprises determining whether the time map information of the designated digital stream is the first time map information or the second time map information, specifying a read address with reference to the time map information by using a time axis according to the type of the time map information, and then starting the playback from the specified address.

7. A program capable of enabling a computer to operate as the recording apparatus according to claim 3.

8. A computer readable recording medium storing the program according to claim 7.

9. A program capable of enabling a computer to operate as the reproducing apparatus according to claim 5.

10. A computer readable recording medium storing the program according to claim 9.
